(19) United States
(12) Patent Application Publication
(10) Pub. No.: US 2024/0004509 A1
(43) Pub. Date: Jan. 4, 2024

(54) CLOSED-LOOP GENERATION OF INSIGHTS FROM SOURCE DATA

(71) Applicant: QlikTech International AB, Lund (SE)

(72) Inventors: José Francisco Díaz López, Lund (SE); Nicholas Magnuson, Park City, UT (US)

(21) Appl. No.: 18/341,262

(22) Filed: Jun. 26, 2023

Related U.S. Application Data
(60) Provisional application No. 63/358,149, filed on Jul. 3, 2022.

(51) Int. Cl. G06F 3/0481; G06F 16/583; G06F 3/04842

(52) U.S. Cl. CPC G06F 3/0481; G06F 16/583; G06F 3/04842

(57) ABSTRACT

Methods and systems for determining insights from source data associated with an entity are described herein. The insights may be based on a difference(s) between source data associated with an entity, which may represent real/historical data, and input data associated with the entity, which may be separate from the source data. Images of user interface objects, such as charts or graphs representative of one or more metrics associated with the entity, may be analyzed using a machine-learning model to determine such insights. For example, additional user interface objects indicative of the difference(s) between the source data and the input data may be generated by the machine-learning model using imaging data and imaging metadata associated with images of the charts or graphs representative of the one or more metrics data.

### CROSS-REFERENCE TO RELATED PATENT APPLICATION

This application claims priority to U.S. Provisional App. No. 63/358,149, filed on Jul. 3, 2022, the entirety of which is incorporated by reference herein.

### SUMMARY

It is to be understood that both the following general description and the following detailed description are illustrative and explanatory only and are not restrictive.

In one embodiment, the disclosure provides a computer-implemented method. The computer-implemented method includes accessing dashboard data based on a query defining an entity, the dashboard data comprising imaging data and imaging metadata. The computer-implemented method also includes determining, using the dashboard data, an analytic model that updates a definition of the entity.

In another embodiment, the disclosure provides a computer-implemented method. The computer-implemented method includes accessing dashboard data based on source data and an analytic model representing a definition of an entity. The computer-implemented method also includes determining, based on the dashboard data, a second analytic model that updates the definition of the entity. The computer-implemented method further includes storing the updated definition of the entity.

Additional elements or advantages of this disclosure will be set forth in part in the description which follows, and in part will be apparent from the description, or may be learned by practice of the subject disclosure. The advantages of the subject disclosure can be attained by means of the elements and combinations particularly pointed out in the appended claims.

This summary is not intended to identify critical or essential features of the disclosure, but merely to summarize certain features and variations thereof. Other details and features will be described in the sections that follow. Further, both the foregoing general description and the following detailed description are illustrative and explanatory only and are not restrictive of the embodiments of this disclosure.

### BRIEF DESCRIPTION OF THE DRAWINGS

The annexed drawings are an integral part of the disclosure and are incorporated into the subject specification. The drawings illustrate example embodiments of the disclosure and, in conjunction with the description and claims, serve to explain at least in part various principles, elements, or aspects of the disclosure. Embodiments of the disclosure are described more fully below with reference to the annexed drawings. However, various elements of the disclosure can be implemented in many different forms and should not be construed as limited to the implementations set forth herein. Like numbers refer to like elements throughout.

FIG. 1 is a schematic diagram showing an embodiment of a system forming an implementation of the disclosed methods.

FIG. 2A is a set of tables showing exemplary Tables 1-5 of a simple database and associations between variables in the tables.

FIG. 2B shows exemplary handles built from Tables 1-5 of FIG. 2A.

FIG. 3 is a schematic flowchart showing basic steps performed when extracting information from a database.

FIG. 4 shows tables showing a final data structure, e.g. a multidimensional cube, created by evaluating mathematical functions.

FIG. 5A is a schematic diagram showing how a selection by a user operates on a scope to generate a data subset.

FIG. 5B is an overview of the relations between data model, indexes in disk and windowed view of disk indexes in memory.

FIG. 5C is a representation of the data structure used for table handling.

FIG. 5D is a table tree representation of a data model.

FIG. 5E shows an example application of bidirectional table indexes and bidirectional association indexes.

FIG. 6 is a schematic graphical presentation showing selections and a diagram of data associated to the selections as received after processing by an external engine.

FIG. 7 is a schematic representation of data exchanged with an external engine based on selections in FIG. 6.

FIG. 8 is a schematic graphical presentation showing selections and a diagram of data associated to the selections as received after second computations from an external engine.

FIG. 9 is a schematic representation of data exchanged with an external engine based on selections in FIG. 8.

FIG. 10 is a schematic graphical presentation showing selections and a diagram of data associated to the selections as received after third computations from an external engine.

FIG. 11 is a schematic representation of data exchanged with an external engine based on selections in FIG. 10.

FIG. 12 is a table showing results from computations based on different selections in the presentation of FIG. 10.

FIG. 13 is a schematic graphical presentation showing a further set of selections and a diagram of data associated to the selections as received after third computations from an external engine.

FIG. 14 shows an example of an operating environment for generation of insights, in accordance with one or more embodiments of this disclosure.

FIG. 15A shows a schematic diagram of an example of a user interface (UI) that conveys insights, in accordance with one or more embodiments of this disclosure.

FIG. 15B shows an example of a UI that conveys insights, in accordance with one or more embodiments of this disclosure.

FIG. 16A shows an example of a data model including associations among fields within a group of tables, in accordance with one or more embodiments of this disclosure.

FIG. 16B shows examples of select fields corresponding to a precursor definition of an entity, in accordance with one or more embodiments of this disclosure.

FIG. 17 shows an example of a process flow for generation of insights, in accordance with one or more embodiments of this disclosure.

FIG. 18 shows an example of a process flow for generation of versions of analytic models, in accordance with one or more embodiments of this disclosure.

FIG. 19 shows a flowchart for an example method.

FIG. 20 shows an example of a method for generating versions of analytic models, in accordance with one or more embodiments of this disclosure.

FIG. 21 shows an example of a computing system in accordance with one or more embodiments of this disclosure.

FIG. 22 shows an example of another computing system in accordance with one or more embodiments of this disclosure.

### DETAILED DESCRIPTION

The disclosure recognizes and addresses, among other technical challenges, the issue of generation of knowledge corresponding to features that collectively represent concepts pertaining to a particular entity implicitly defined by a corpus of data. Such knowledge can be generically referred to as an knowledge insight, and can be derived from data insight. A data insight can include features of corpus of data. Embodiments of this disclosure, include systems, devices, computer-implemented methods, and computer program products that, individually or in combination, permit generation of data views that both individually and collectively represent complex features of a corpus of data associated with an entity. Examples of the entity include “good student,” “good electric vehicle,” “good suburban city,” and similar. A group of complex features, individually or collectively, represent a knowledge insight associated with the entity. Embodiments of this disclosure, individually or in combination, also permit generating an analytic model that can synthetize a group of insights into an unbiased, data-driven definition of the entity. The analytic model synthesizes the group of data insights by means of a set of one or multiple parameters and a set of one or multiple procedures. The parameter(s) and the procedure(s) collectively represent correlations present in source data and/or derivative data underlying the data views. Those correlations can embody a mapping between data within a corpus of data and select data-model fields (or dimensions) defining a model/precursor definition of the entity. Because the analytic model can be computer-operable, embodiments of this disclosure can use the analytic model to generate, based on the corpus of data, additional insights corresponding to the entity. Hence, embodiments of this disclosure can provide a closed-loop pathway for generation of insights from source data.

By relying on data and underlying patterns within the data, definition of an entity is not subjective. Instead, the definition reveals underlying implicit structure within the data, and is thus independent of bias of a human agent defining the entity.

The disclosed technologies can incorporate external data analysis into an otherwise closed data analysis environment. A typical environment for the computing systems and methods described herein is for assisting in a computer-implemented method for building and updating a multi-dimensional cube data structure, such as the systems and methods described in U.S. Pat. Nos. 7,058,621; 8,745,099; 8,244,741; and U.S. patent application Ser. No. 14/054,321, which are incorporated by reference in their entireties.

In some aspects, the disclosed technologies can manage associations among data sets with every data point in the analytic dataset being associated with every other data point in the dataset. Datasets can be larger than hundreds of tables with thousands of fields. A multi-dimensional dataset or array of data is referred to as an OnLine Analytic Processing (OLAP) cube. A cube can be considered a multi-dimensional generalization of a two- or three-dimensional spreadsheet. For example, it may be desired to summarize data by product, by time-period, and by city to compare actual expenses and budget expenses. Product, time, city, and scenario (actual and budget) can be referred to as dimensions. A multi-dimensional dataset is normally called a hypercube if the number of dimensions is greater than 3. A hypercube can comprise tuples made of two (or more) dimensions and one or more expressions.

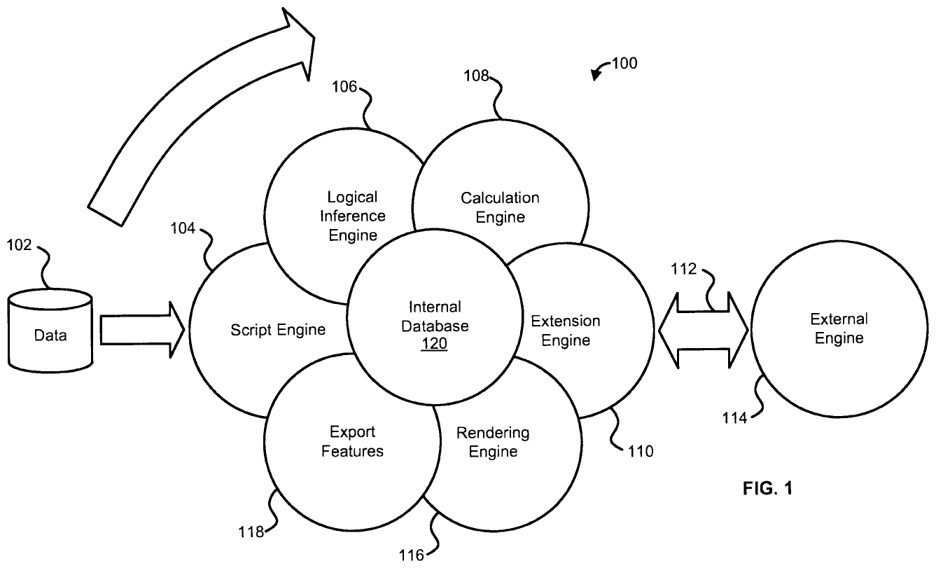

With reference to the drawings, FIG. 1 shows an associative data indexing engine 100 with data flowing in from the left and operations starting from a script engine 104 and going clockwise (indicated by the clockwise arrow) to export features 118. Data from a data source 102 can be extracted by a script engine 104. The data source 102 can comprise any type of known database, such as relational databases, post-relational databases, object-oriented databases, hierarchical databases, flat files, spread sheet, etc. The Internet may also be regarded as a database in the context of the present disclosure. A visual interface can be used as an alternative or combined with a script engine 104. The script engine 104 can read record by record from the data source 102 and data can be stored or appended to symbol and data tables in an internal database 120. Read data can be referred to as a data set.

In an aspect, the extraction of the data can comprise extracting an initial data set or scope from the data source 102, e.g. by reading the initial data set into the primary memory (e.g. RAM) of the computer. The initial data set can comprise the entire contents of the data source 102 base, or a subset thereof. The internal database 120 can comprise the extracted data and symbol tables. Symbol tables can be created for each field and, in one aspect, can only contain the distinct field values, each of which can be represented by their clear text meaning and a bit filled pointer. The data tables can contain said bit filled pointers.

In the case of a query of the data source 102, a scope can be defined by the tables included in a SELECT statement (or equivalent) and how these are joined. In an aspect, the SELECT statement can be SQL (Structured Query Language) based. For an Internet search, the scope can be an index of found web pages, for example, organized as one or more tables. A result of scope definition can be a data set.

Once the data has been extracted, a user interface can be generated to facilitate dynamic display of the data. By way of example, a particular view of a particular dataset or data subset generated for a user can be referred to as a state space or a session. The methods and systems can dynamically generate one or more visual representations of the data to present in the state space.

A user can make a selection in the data set, causing a logical inference engine 106 to evaluate a number of filters on the data set. In an aspect, a query on a database that holds data of placed orders, could be requesting results matching an order year of ‘1999’ and a client group be ‘Nisse.’ The selection may thus be uniquely defined by a list of included fields and, for each field, a list of selected values or, more generally, a condition. Based on the selection, the logical inference engine 106 can generate a data subset that represents a part of the scope. The data subset may thus contain a set of relevant data records from the scope, or a list of references (e.g. indices, pointers, or binary numbers) to these relevant data records. The logical inference engine 106 can process the selection and can determine what other selections are possible based on the current selections. In an aspect, flags can enable the logical inference engine 106 to work out the possible selections. By way of example, two flags can be used: the first flag can represent whether a value is selected or not, the second can represent whether or not a value selection is possible. For every click in an application, states and colors for all field values can be calculated. These can be referred to as state vectors, which can allow for state evaluation propagation between tables.

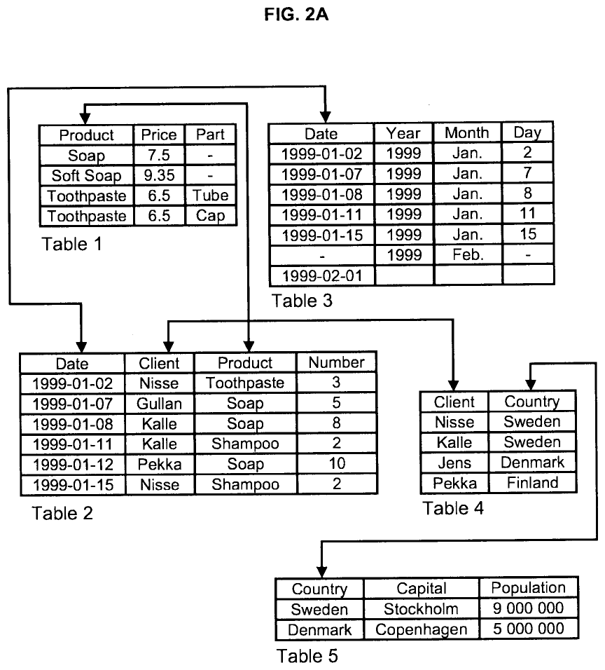

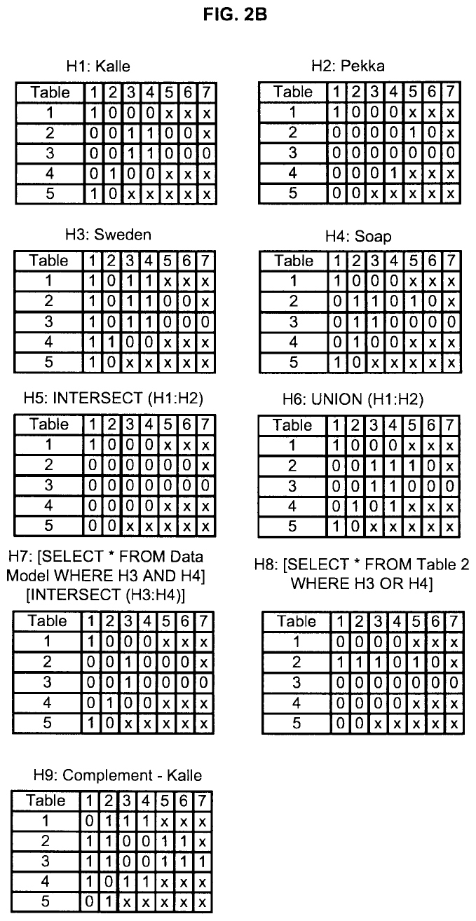

In another aspect, the query can comprise a selection query language. The selection query language can comprise a query language that operates on selection states of data, rather than on the actual data. In an aspect, one or more handles can be generated (e.g., in real-time or as part of data extraction). A handle can represent a selection state of all rows of all tables in the underlying data based on an attribute. FIG. 2A shows example tables and associations between the tables. FIG. 2B shows handles H1, H2, H3, and H4. Handle H1 represents selection states of all rows of Tables 1-5 based on a selection of “Kalle”. Handle H2 represents selection states of all rows of Tables 1-5 based on a selection of “Pekka”. Handle H3 represents selection states of all rows of Tables 1-5 based on a selection of “Sweden”. Handle H4 represents selection states of all rows of Tables 1-5 based on a selection of “Soap”. In the handles, each row can represent a table and each column can represent a row. For example, in the handle H1, the row associated with Table 1 contains a “1” in column 1, a “0” in columns 2-4, and an “x” in columns 5-7. As a result, handle H1 indicates that “Kalle” is associated with row 1 in Table 1, “Kalle” is not associated with rows 2-4 in Table 1, and Table 1 does not contain rows 5-7. Note that an indication of “1”, “0”, and “x” is exemplary, and other values and/or symbols can be used. It should be understood that an indication of “1” does not indicate that the value represented by the handle is present in that row, but rather that the value is associated with that row.

The selection query language disclosed herein can perform one or more operations, including but not limited to, SET HANDLE H (H0, HU special handles (no selection/none possible)), SELECT, WHERE, COMPLEMENT, UNION, INTERSECT, STATE (n), UPDATE, AGGR, SORT, SESSION, PAGE, IN, ON, WITH, FROM, combinations thereof, and the like. FIG. 2B shows an example of an INTERSECT operation performed on H1 and H2. Unlike performance of an INTERSECT operation via traditional SQL which would return actual distinct rows by comparing the results of two queries, an INTERSECT operation performed on two handles returns another handle. As shown in FIG. 2B, an INTERSECT of H1 and H2 results in handle H6. FIG. 2B also shows the results of a UNION operation performed on handles H1 and H2, resulting in handle H6.

FIG. 2B shows an application of a SELECT statement via the selection query language. Consider the following statement, SELECT*FROM Data Model WHERE Country=Sweden AND Product=Soap. Traditional SQL would traverse all tables and all rows to identify and return each row that contains both “Sweden” and “Soap”. Such a traversal is both time and processor intensive. Applying the SELECT statement via the selection query language results in SELECT*FROM Data Model WHERE H3 AND H4 (which consequently can be expressed as INTERSECT (H3:H4)), resulting in generation of handle H7.

FIG. 2B shows another application of a SELECT statement via the selection query language. Consider the following statement, SELECT*FROM Table 2 WHERE Country=Sweden OR Product=Soap. Traditional SQL would traverse all rows of Table 2 to identify and return each row that contains both “Sweden” and “Soap”. Applying the SELECT statement via the selection query language results in SELECT*FROM Table 2 WHERE H3 OR H4, resulting in generation of handle H8.
SET HANDLE H1=SELECT Client=“Kalle” IN HU
SET HANDLE H3=SELECT Client=“Sweden” IN HU

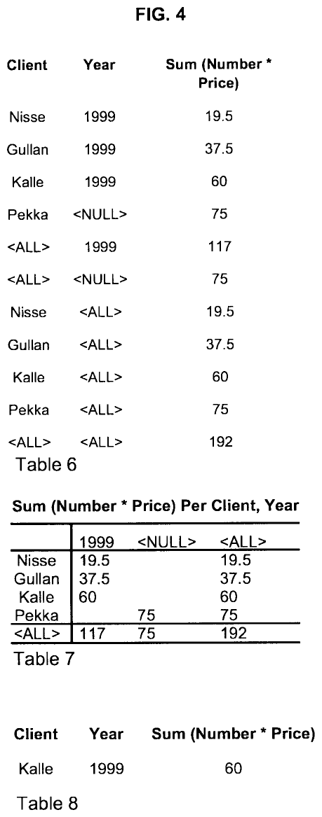

The selection query language can be used to generate a handle for a hypercube. For example, SET HCUBE HC1=AGGR SUM(Number*Price) WITH Client,Year on HU. Such a query can generate a handle for a hypercube “HC1” that represents results of the mathematical function (“SUM(Price*Number)”) based on the results of the mathematical expression (“Price*Number”), as applied to the entire data set “HU”. HU can be a handle that represents the universe of data. The underlying data from the query can be obtained (e.g., fetched) via a PAGE operation. For example, PAGE HC1 OFFSET 0 LENGTH ALL can return the actual data values represented by the handle “HC1”, the output of which is shown in Table 6 of FIG. 4. The PAGE operation can be used to customize which values are fetched. For example, PAGE HC1 OFFSET 0 LENGTH 2 can return the actual data values in the first two rows in Table 6 of FIG. 4.

In another example, the selection query language can be used to generate a handle for a hypercube based on other handles. For example, SET HCUBE HC2=AGGR SUM(Number*Price) WITH Client,Year on INTERSECT(H1,H3). Such a query can generate a handle for a hypercube “HC2” that represents results of the mathematical function (“SUM(Price*Number)”) based on the results of the mathematical expression (“Price*Number”), as applied to the intersection of handles H1 and H3. The underlying data from the query can be obtained (e.g., fetched) via a PAGE operation. For example, PAGE HC2 OFFSET 0 LENGTH ALL can return the actual data values represented by the handle “HC2”, the output of which is shown in Table 8 of FIG. 4.

The PAGE operation can be used to fetch customized values from one or more handles, operations on handles, and/or the entire data set. For example, PAGE Client OFFSET 0 LENGTH 2 can return the actual data values from the entire dataset to which it is applied. The actual data values returned based on the example query would be the first two entries on the field “Client”. As applied to the tables in FIG. 2, the values returned would be rows 1 and 2 from Table 2 as Table 2 is the first table that would be loaded that contains the field “Client”.

Another example of a PAGE operation is PAGE Client OFFSET 0 LENGTH 2 WITH STATE=Active ON COMPLEMENT H1. Such a PAGE operation would determine the first two entries on the field “Client” retrieved from the complement of H1 having an “Active” (e.g., “1”) state. The complement of H1 represents inverted state values of the handle H1. The complement of H1 is shown in FIG. 2B as H9, although creation of a separate handle H9 is not necessary to the processing of the PAGE operation. The only tables in FIG. 2 that contain values for the field “Client” are Table 2 and Table 4. As shown in handle H9, as applied to the tables in FIG. 2, the active values in the rows for Table 2 and Table 4 represent underlying data values for Table 2: rows 1, 2, 5, and 6 and for Table 4: rows 2, 3, and 4. However, as the PAGE operation requested the first two rows, the actual data values returned would be rows 1 and 2 from Table 2, as Table 2 is loaded before Table 4.

The selection query language can be used to perform set analysis. Set analysis is a method of defining a set of data values that is different from a set defined by current selections. Set analysis can comprise an aggregation on a field with a condition. An example of set analysis can be SUM($1<Year={19991>}(Price*Number)) which would provide a sum of all sales in 1999, the sum being updated based on user selections (defined as “$” to respect current selections, “1” to ignore current selections, and 1-$ to use records excluded by current selections). The set analysis would output the total sales in 1999, and if the user selected “Nisse” for example, the total sales in 1999 would be adjusted down to reflect only those sales in 1999 related to “Nisse”.

An example of applying selection query language to set analysis is the following operations, SET HCUBE HCT=AGGR SUM(Number*Price) on HU which can create a handle for a hypercube “HCT” that represents results of the mathematical function (“SUM(Price*Number)”) based on the results of the mathematical expression (“Price*Number”), as applied to all data “HU”. A user selection of “Kalle” and “Sweden” can result in a follow on operation SET HCUBE HC %=AGGR 100*SUM(Number*Price)/HCT on INTERSECT(H1,H3) that can be executed to create a handle “HC %” for a hypercube that represents the determination of the percentage of sales related to “Kalle” and “Sweden” (INTERSECT(H1,H3)). The actual underlying data values can be fetched with a PAGE operation such as PAGE HC % OFFSET 0 LENGTH ALL.

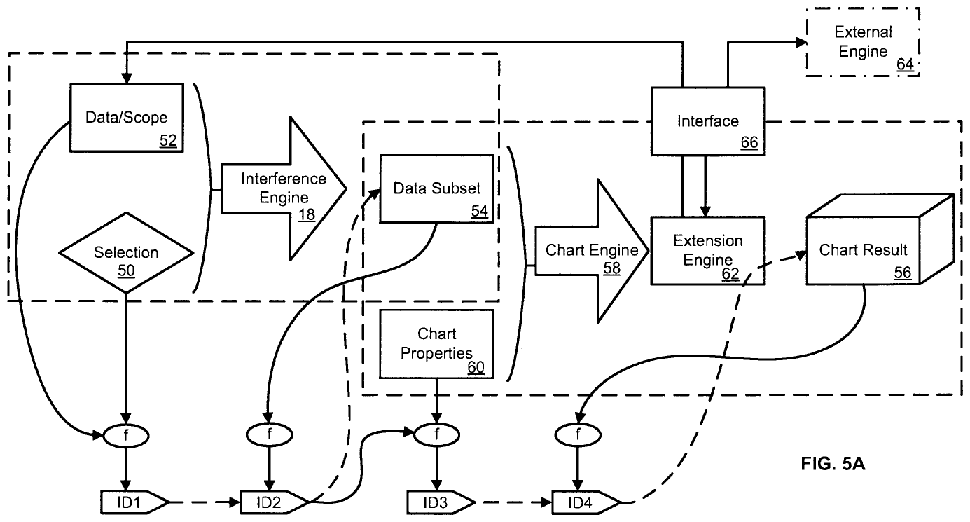

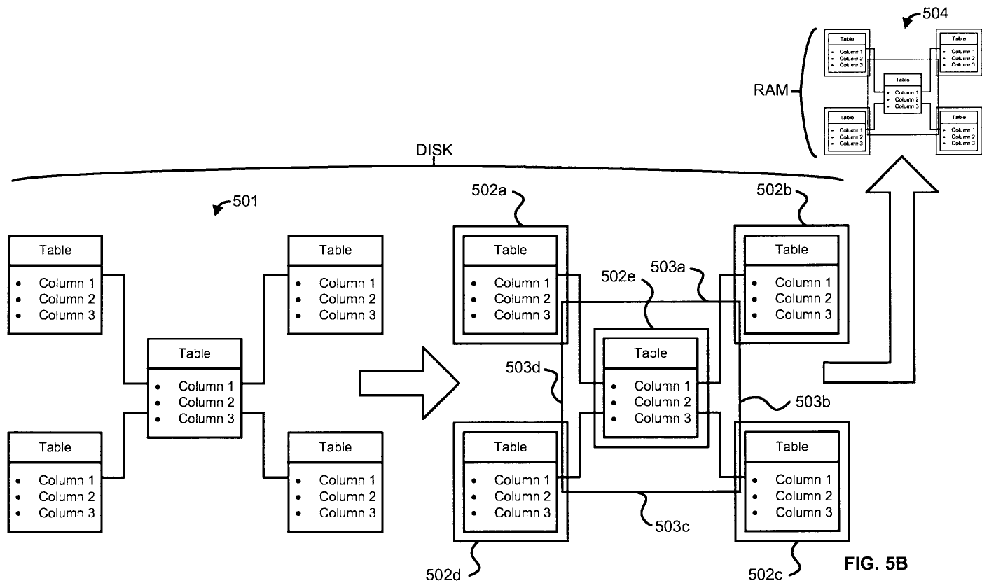

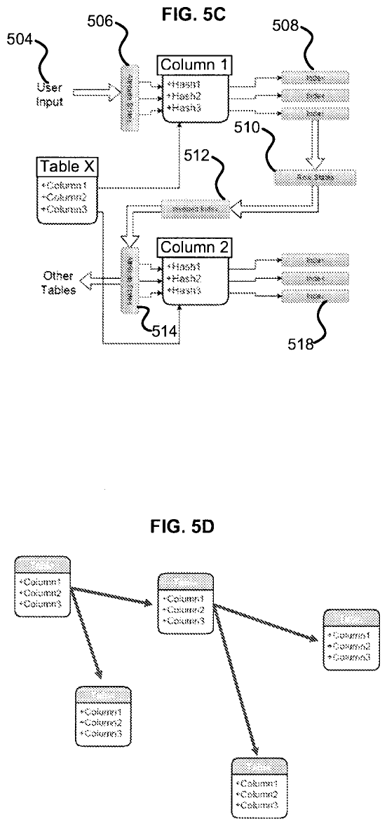

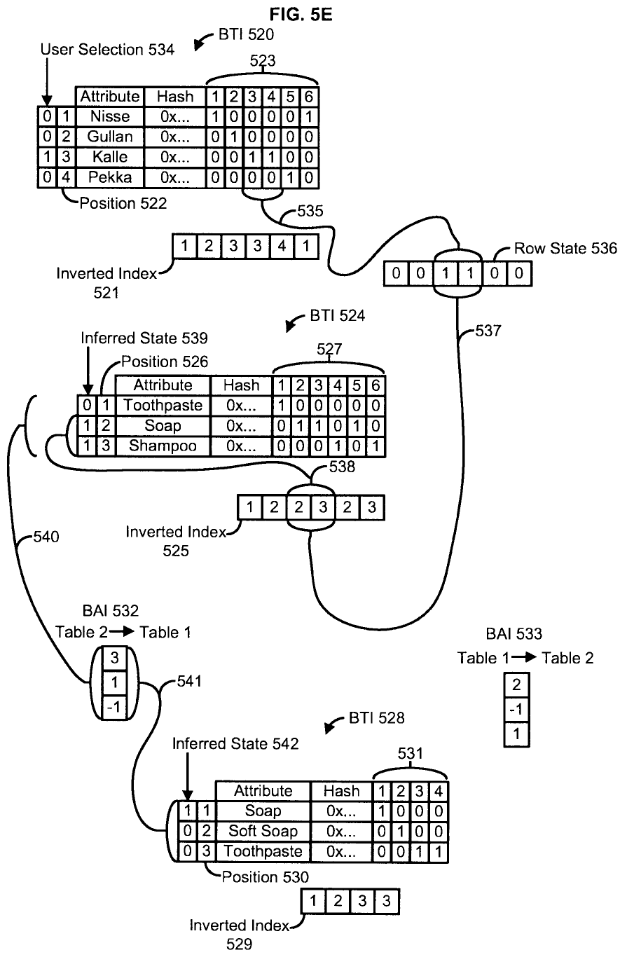

The logical inference engine 106 can utilize an associative model to connect data. In the associative model, all the fields in the data model have a logical association with every other field in the data model. An example, data model 501 is shown in FIG. 5B. The data model 501 shows connections between a plurality of tables which represent logical associations. Depending on the amount of data, the data model 501 can be too large to be loaded into memory. To address this issue, the logical inference engine 106 can generate one or more indexes for the data model. The one or more indexes can be loaded into memory in lieu of the data model 501. The one or more indexes can be used as the associative model. An index is used by database management programs to provide quick and efficient associative access to a table's records. An index is a data structure (for example, a B-tree, a hash table, and the like) that stores attributes (e.g., values) for a specific column in a table. A B-tree is a self-balancing tree data structure that keeps data sorted and allows searches, sequential access, insertions, and deletions in logarithmic time. The B-tree is a generalization of a binary search tree in that a node can have more than two children. A hash table (also referred to as a hash index) can comprise a collection of buckets organized in an array. A hash function maps index keys to corresponding buckets in the hash index.

Queries that compare for equality to a string can retrieve values very fast using a hash index. For instance, referring to the tables of FIG. 2, a query of (in SQL: SELECT*FROM Table 2 WHERE Client=‘Kalle’ or in selection query language: SELECT*FROM Table 2 WHERE H1) could benefit from a hash index created on the Client column. In this example, the hash index would be configured such that the column value will be the key into the hash index and the actual value mapped to that key would just be a pointer to the row data in Table 2. Since a hash index is an associative array, a typical entry can comprise “Kalle=>0x29838”, where is a reference to the table row where Kalle is stored in memory. Thus, looking up a value of “Kalle” in a hash index can return a reference to the row in memory which is faster than scanning Table 2 to find all rows with a value of “Kalle” in the Client column. The pointer to the row data enables retrieval of other values in the row.

As shown in FIG. 5B, the logical inference engine 106 can be configured for generating one or more bidirectional table indexes (BTI) 502a, 502b, 502c, 502d, and/or 502e and one or more bidirectional associative indexes (BAI) 503a, 503b, 503c and/or 503d based on a data model 501. The logical inference engine 106 can scan each table in the data model 501 and create the BTI 502a, 502b, 502c, 502d, and/or 502e. A BTI can be created for each column of each table in the data. The BTI 502a, 502b, 502c, 502d, and/or 502e can comprise a hash index. The BTI 502a, 502b, 502c, 502d, and/or 502e can comprise first attributes and pointers to the table rows comprising the first attributes. For example, referring to the tables of FIG. 2, an example BTI 502a can comprise “Kalle=>0x29838”, where Kalle is an attribute found in Table 2 and 0x29838 is a reference to the row in Table 2 where Kalle is stored in memory. Thus, the BTI 502a, 502b, 502c, 502d, and/or 502e can be used to determine other attributes in other columns (e.g., second attributes, third attributes, etc. . . . ) in table rows comprising the first attributes. Accordingly, the BTI can be used to determine that an association exists between the first attributes and the other attributes.

The logical inference engine 106 can scan one or more of BTI 502a, 502b, 502c, 502d, and/or 502e and create the BAI 503a, 503b, 503c and/or 503d. The BAI 503a, 503b, 503c and/or 503d can comprise a hash index. The BAI 503a, 503b, 503c and/or 503d can comprise an index configured for connecting attributes in a first table to common columns in a second table. The BAI 503a, 503b, 503c and/or 503d thus allows for identification of rows in the second table which then permits identification of other attributes in other tables. For example, referring to the tables of FIG. 2, an example BAI 503a can comprise “Kalle=>0x39838”, where Kalle is an attribute found in Table 2 and 0x39838 is a reference to a row in Table 4 that contains Kalle. In an aspect, the reference can be to a hash that can be in-memory or on disk.

Using the BTI 502a, 502b, 502c, 502d, and/or 502e and the BAI 503a, 503b, 503c, and/or 503d, the logical inference engine 106 can generate an index window 504 by taking a portion of the data model 501 and mapping it into memory. The portion of the data model 501 taken into memory can be sequential (e.g., not random). The result is a significant reduction in the size of data required to be loaded into memory.

Thus, the logical inference engine 106 can determine a data subset based on user selections. The logical inference engine 106 automatically maintains associations among every piece of data in the entire data set used in an application. The logical inference engine 106 can store the binary state of every field and of every data table dependent on user selection (e.g., included or excluded). This can be referred to as a state space and can be updated by the logical inference engine 106 every time a selection is made. There is one bit in the state space for every value in the symbol table or row in the data table, as such the state space is smaller than the data itself and faster to query. The inference engine will work associating values or binary symbols into the dimension tuples. Dimension tuples are normally needed by a hypercube to produce a result.

The associations thus created by the logical inference engine 106 means that when a user makes a selection, the logical inference engine 106 can resolve (quickly) which values are still valid (e.g., possible values) and which values are excluded. The user can continue to make selections, clear selections, and make new selections, and the logical inference engine 106 will continue to present the correct results from the logical inference of those selections. In contrast to a traditional join model database, the associative model provides an interactive associative experience to the user.

FIG. 5C, shows an example application of one or more BTIs. User input 504 can be received that impacts a selection of one or more attribute states 506. Attribute states 506 can correspond to selection by a user of one or more attributes (e.g., values) found in Column 1 of Table X. In an aspect, the one or more attributes of Table X can comprise a hash of each respective attribute. One or more BTI's 508 can be accessed to determine one or more rows in Table X that comprise the attributes selected by the user. Row states 510 can correspond to selection of one or more rows found in Table X that comprise the one or more selected attributes. An inverted index 512 of Column 2 can be accessed to identify which rows of Table 1 comprise associated attributes. Attribute states 514 for Column 2 can be updated to reflect the associated attributes of Column 2. One or more BTI's 518 can be further accessed to determine other associated attributes in other columns as needed. Attribute states 514 can be applied to other tables via one or more BAIs. FIG. 5D shows an example of relationships identified by one or more BAIs.

FIG. 5E shows an example application of BTI's and BAI's to determine inferred states both inter-table and intra-table using Table 1 and Table 2 of FIG. 2. A BTI 520 can be generated for the “Client” attribute of Table 2. In an aspect, the BTI 520 can comprise an inverted index 521. In other aspect, the inverted index 521 can be considered a separate structure. The BTI 520 can comprise a row for each unique attribute in the “Client” column of Table 2. Each unique attribute can be assigned a corresponding position 522 in the BTI 520. In an aspect, the BTI 520 can comprise a hash for each unique attribute. The BTI 520 can comprise a column 523 for each row of Table 2. For each attribute, a “1” can indicate the presence of the attribute in the row and a “0” can indicate an absence of the attribute from the row. “0” and “1” are merely examples of values used to indicate presence or absence. Thus, the BTI 520 reflects that the attribute “Nisse” is found in rows 1 and 6 of Table 2, the attribute “Gullan” is found in row 2 of Table 2, the attribute “Kalle” is found in rows 3 and 4 of Table 2, and the attribute “Pekka” is found in row 5 of Table 2.

The inverted index 521 can be generated such that each position in the inverted index 521 corresponds to a row of Table 2 (e.g., first position corresponds to row 1, second position corresponds to row 2, etc. . . . ). A value can be entered into each position that reflects the corresponding position 522 for each attribute. Thus, in the inverted index 521, position 1 comprises the value “1” which is the corresponding position 522 value for the attribute “Nisse”, position 2 comprises the value “2” which is the corresponding position 522 value for the attribute “Gullan”, position 3 comprises the value “3” which is the corresponding position 522 value for the attribute “Kalle”, position 4 comprises the value “3” which is the corresponding position 522 value for the attribute “Kalle”, position 5 comprises the value “4” which is the corresponding position 522 value for the attribute “Pekka”, and position 6 comprises the value “1” which is the corresponding position 522 value for the attribute “Nisse”.

A BTI 524 can be generated for the “Product” attribute of Table 2. In an aspect, the BTI 524 can comprise an inverted index 525. In other aspect, the inverted index 525 can be considered a separate structure. The BTI 524 can comprise a row for each unique attribute in the “Product” column of Table 2. Each unique attribute can be assigned a corresponding position 526 in the BTI 524. In an aspect, the BTI 524 can comprise a hash for each unique attribute. The BTI 524 can comprise a column 527 for each row of Table 2. For each attribute, a “1” can indicate the presence of the attribute in the row and a “0” can indicate an absence of the attribute from the row. “0” and “1” are merely examples of values used to indicate presence or absence. Thus, the BTI 524 reflects that the attribute “Toothpaste” is found in row 1 of Table 2, the attribute “Soap” is found in rows 2, 3, and 5 of Table 2, and the attribute “Shampoo” is found in rows 4 and 6 of Table 2.

By way of example, the inverted index 525 can be generated such that each position in the inverted index 525 corresponds to a row of Table 2 (e.g., first position corresponds to row 1, second position corresponds to row 2, etc. . . . ). A value can be entered into each position that reflects the corresponding position 526 for each attribute. Thus, in the inverted index 525, position 1 comprises the value “1” which is the corresponding position 526 value for the attribute “Toothpaste”, position 2 comprises the value “2” which is the corresponding position 526 value for the attribute “Soap”, position 3 comprises the value “2” which is the corresponding position 526 value for the attribute “Soap”, position 4 comprises the value “3” which is the corresponding position 526 value for the attribute “Shampoo”, position 5 comprises the value “2” which is the corresponding position 526 value for the attribute “Soap”, and position 6 comprises the value “3” which is the corresponding position 526 value for the attribute “Shampoo”.

By way of example, a BTI 528 can be generated for the “Product” attribute of Table 1. In an aspect, the BTI 528 can comprise an inverted index 529. In other aspect, the inverted index 529 can be considered a separate structure. The BTI 528 can comprise a row for each unique attribute in the “Product” column of Table 1. Each unique attribute can be assigned a corresponding position 530 in the BTI 528. In an aspect, the BTI 528 can comprise a hash for each unique attribute. The BTI 528 can comprise a column 531 for each row of Table 1. For each attribute, a “1” can indicate the presence of the attribute in the row and a “0” can indicate an absence of the attribute from the row. “0” and “1” are merely examples of values used to indicate presence or absence. Thus, the BTI 528 reflects that the attribute “Soap” is found in row 1 of Table 1, the attribute “Soft Soap” is found in row 2 of Table 1, and the attribute “Toothpaste” is found in rows 3 and 4 of Table 1.

By way of example, the inverted index 529 can be generated such that each position in the inverted index 529 corresponds to a row of Table 1 (e.g., first position corresponds to row 1, second position corresponds to row 2, etc. . . . ). A value can be entered into each position that reflects the corresponding position 530 for each attribute. Thus, in the inverted index 529, position 1 comprises the value “1” which is the corresponding position 530 value for the attribute “Soap”, position 2 comprises the value “2” which is the corresponding position 530 value for the attribute “Soft Soap”, position 3 comprises the value “3” which is the corresponding position 530 value for the attribute “Toothpaste”, and position 4 comprises the value “3” which is the corresponding position 530 value for the attribute “Toothpaste”.

By way of example, a BAI 532 can be generated as an index between the product attribute of Table 2 and Table 1. The BAI 532 can comprise a row for each unique attribute in the BTI 524 by order of corresponding position 526. The value in each row can comprise the corresponding position 530 of the BTI 528. Thus, position 1 of the BAI 532 corresponds to “Toothpaste” in the BTI 524 (corresponding position 526 of 1) and comprises the value “3” which is the corresponding position 530 for “Toothpaste” of the BTI 528. Position 2 of the BAI 532 corresponds to “Soap” in the BTI 524 (corresponding position 526 of 2) and comprises the value “1” which is the corresponding position 530 for “Soap” of the BTI 528. Position 3 of the BAI 532 corresponds to “Shampoo” in the BTI 524 (corresponding position 526 of 3) and comprises the value “−1” which indicates that the attribute “Shampoo” is not found in Table 1.

By way of example, a BAI 533 can be created to create an index between the product attribute of Table 1 and Table 2. The BAI 533 can comprise a row for each unique attribute in the BTI 528 by order of corresponding position 530. The value in each row can comprise the corresponding position 526 of the BTI 524. Thus, position 1 of the BAI 533 corresponds to “Soap” in the BTI 528 (corresponding position 530 of 1) and comprises the value “2” which is the corresponding position 526 for “Soap” of the BTI 524. Position 2 of the BAI 533 corresponds to “Soft Soap” in the BTI 528 (corresponding position 530 of 2) and comprises the value “−1” which indicates that the attribute “Soft Soap” is not found in Table 2. Position 3 of the BAI 533 corresponds to “Toothpaste” in the BTI 528 (corresponding position 530 of 3) and comprises the value “1” which is the corresponding position 526 for “Toothpaste” of the BTI 524.

FIG. 5E shows an example application of the logical inference engine 106 utilizing the BTI 520, the BTI 524, and the BTI 528. A user can select the “Client” “Kalle” from within a user interface. A column for a user selection 534 of “Kalle” can be indicated in the BTI 520 comprising a value for each attribute that reflects the selection status of the attribute. Thus, the user selection 534 comprises a value of “0” for the attribute “Nisse” indicating that “Nisse” is not selected, the user selection 534 comprises a value of “0” for the attribute “Gullan” indicating that “Gullan” is not selected, the user selection 534 comprises a value of “1” for the attribute “Kalle” indicating that “Kalle” is selected, and the user selection 534 comprises a value of “0” for the attribute “Pekka” indicating that “Pekka” is not selected.

The BTI 520 can be consulted to determine that the attribute “Kalle” has a value of “1” in the column 523 corresponding to rows 3 and 4. In an aspect, the inverted index 521 can be consulted to determine that the user selection 534 relates to the position 522 value of “3” which is found in the inverted index 521 at positions 3 and 4, implicating rows 3 and 4 of Table 1. Following path 535, a row state 536 can be generated to reflect the user selection 534 as applied to the rows of Table 2. The row state 536 can comprise a position that corresponds to each row and a value in each position reflecting whether a row was selected. Thus, position 1 of the row state 536 comprises the value “0” indicating that row 1 does not contain “Kalle”, position 2 of the row state 536 comprises the value “0” indicating that row 2 does not contain “Kalle”, position 3 of the row state 536 comprises the value “1” indicating that row 3 does contain “Kalle”, position 4 of the row state 536 comprises the value “1” indicating that row 4 does contain “Kalle”, position 5 of the row state 536 comprises the value “0” indicating that row 5 does not contain “Kalle”, and position 6 of the row state 536 comprises the value “0” indicating that row 6 does not contain “Kalle”.

Following path 537, the row state 536 can be compared with the inverted index 525 to determine the corresponding position 526 contained in the inverted index 525 at positions 3 and 4. The inverted index 525 comprises the corresponding position 526 value of “2” in position 3 and the corresponding position 526 value of “3” in position 4. Following path 538, the corresponding position 526 values of “2” and “3” can be determined to correspond to “Soap” and “Shampoo” respectively in the BTI 524. Thus, the logical inference engine 106 can determine that both “Soap” and “Shampoo” in Table 2 are associated with “Kalle” in Table 2. The association can be reflected in an inferred state 539 in the BTI 524. The inferred state 539 can comprise a column with a row for each attribute in the BTI 524. The column can comprise a value indicated the selection state for each attribute. The inferred state 539 comprises a “0” for “Toothpaste” indicating that “Toothpaste” is not associated with “Kalle”, the inferred state 539 comprises a “1” for “Soap” indicating that “Soap” is associated with “Kalle”, and inferred state 539 comprises a “1” for “Shampoo” indicating that “Shampoo” is associated with “Kalle”.

Following path 540, the inferred state 539 can be compared to the BAI 532 to determine one or more associations between the selection of “Kalle” in Table 2 and one or more attributes in Table 1. As the inferred state 539 comprises a value of “1” in both position 2 and position 3, the BAI 532 can be assessed to determine the values contained in position 2 and position 3 of the BAI 532 (following path 541). Position 2 of the BAI 532 comprises the value “1” which identifies the corresponding position 530 of “Soap” and position 3 of the BAI 532 comprises the value “−1” which indicates that Table 1 does not contain “Shampoo”. Thus, the logical inference engine 106 can determine that “Soap” in Table 1 is associated with “Kalle” in Table 2. The association can be reflected in an inferred state 542 in the BTI 528. The inferred state 542 can comprise a column with a row for each attribute in the BTI 528. The column can comprise a value indicated the selection state for each attribute. The inferred state 542 comprises a “1” for “Soap” indicating that “Soap” is associated with “Kalle”, the inferred state 542 comprises a “0” for “Soft Soap” indicating that “Soft Soap” is not associated with “Kalle”, and the inferred state 542 comprises a “0” for “Toothpaste” indicating that “Toothpaste” is not associated with “Kalle”. Based on the current state of BTIs and BAIs, if the data sources 102 indicate that an update or delta change has occurred to the underlying data, the BTIs and BAIs can be updated with corresponding changes to maintain consistency.

Based on current selections and possible rows in data tables a calculation/chart engine 108 can calculate aggregations in objects forming transient hyper cubes in an application. The calculation/chart engine 108 can further build a virtual temporary table from which aggregations can be made. The calculation/chart engine 108 can perform a calculation (e.g., evaluate an expression in response to a user selection/de-selection) via a multithreaded operation. The state space can be queried to gather all of the combinations of dimensions and values necessary to perform the calculation. In an aspect, the query can be on one thread per object, one process, one worker, combinations thereof, and the like. The expression can be calculated on multiple threads per object. Results of the calculation can be passed to a rendering engine 116 and/or optionally to an extension engine 110.

Optionally, the extension engine 110 can be implemented to communicate data via an interface 112 to an external engine 114. In another aspect, the extension engine 110 can communicate data, metadata, a script, a reference to one or more artificial neural networks (ANNs), one or more commands to be executed, one or more expressions to be evaluated, combinations thereof, and the like to the external engine 114. The interface 114 can comprise, for example, an Application Programming Interface (API). The external engine 114 can comprise one or more data processing applications (e.g., simulation applications, statistical applications, mathematical computation applications, database applications, combinations thereof, and the like). The external engine 114 can be, for example, one or more of MATLAB®, R, Maple®, Mathematica®, combinations thereof, and the like.

In an aspect, the external engine 114 can be local to the associative data indexing engine 100 or the external engine 114 can be remote from the associative data indexing engine 100. The external engine 114 can perform additional calculations and transmit the results to the extension engine 110 via the interface 112. A user can make a selection in the data model of data to be sent to the external engine 114. The logical inference engine 106 and/or the extension engine 110 can generate data to be output to the external engine 114 in a format to which the external engine 114 is accustomed to processing. In an example application, tuples forming a hypercube can comprise two dimensions and one expression, such as (Month, Year, Count (ID)), ID being a record identification of one entry. Then said tuples can be exchanged with the external engine 114 through the interface 112 as a table. If the data comprise births there can be timestamps of the births and these can be stored as month and year. If a selection in the data model will give a set of month-year values that are to be sent out to an external unit, the logical inference engine 106 and/or the extension engine 110 can ripple that change to the data model associatively and produce the data (e.g., set and/or values) that the external engine 114 needs to work with. The set and/or values can be exchanged through the interface 112 with the external engine 114. The external engine 114 can comprise any method and/or system for performing an operation on the set and/or values. In an aspect, operations on the set and/or values by the external engine 114 can be based on tuples (aggregated or not). In an aspect, operations on the set and/or values by the external engine 114 can comprise a database query based on the tuples. Operations on the set and/or values by the external engine 114 can be any transformation/operation of the data as long as the cardinality of the result is consonant to the sent tuples/hypercube result.

In an aspect, tuples that are transmitted to the external engine 114 through the interface 112 can result in different data being received from the external engine 114 through the interface 112. For example, a tuple consisting of (Month, Year, Count (ID)) should return as 1-to-1, m-to-1 (where aggregations are computed externally) or n-to-n values. If data received are not what were expected, association can be lost. Transformation of data by the external engine 114 can be configured such that cardinality of the results is consonant to the sent tuples and/or hypercube results. The amount of values returned can thus preserve associativity.

Results received by the extension engine 110 from the external engine 114 can be appended to the data model. In an aspect, the data can be appended to the data model without intervention of the script engine 104. Data model enrichment is thus possible “on the fly.” A natural work flow is available allowing clicking users to associatively extend the data. The methods and systems disclosed permit incorporation of user implemented functionality into a presently used work flow. Interaction with third party complex computation engines, such as MATLAB® or R, is thus facilitated.

The logical inference engine 106 can couple associated results to the external engine 114 within the context of an already processed data model. The context can comprise tuple or tuples defined by dimensions and expressions computed by hypercube routines. Association is used for determination of which elements of the present data model are relevant for the computation at hand. Feedback from the external engine 114 can be used for further inference inside the inference engine or to provide feedback to the user.

In an aspect, one or more handles that were generated prior to receiving results from the external engine 114 can be updated after the results have been appended to the data model. For example, if one or more values in one or more tables changes because of the results from the external engine 114, an UPDATE operation can be performed to refresh the handles to reflect changes in the underlying data.

A rendering engine 116 can produce a desired graphical object (charts, tables, etc) based on selections/calculations. When a selection is made on a rendered object there can be a repetition of the process of moving through one or more of the logical inference engine 106, the calculation/chart engine 108, the extension engine 110, the external engine 114, and/or the rendering engine 116. The user can explore the scope by making different selections, by clicking on graphical objects to select variables, which causes the graphical object to change. At every time instant during the exploration, there exists a current state space, which is associated with a current selection state that is operated on the scope (which always remains the same).

Different export features or tools 118 can be used to publish, export or deploy any output of the associative data indexing engine 100. Such output can be any form of visual representation, including, but not limited to, textual, graphical, animation, audio, tactile, and the like. The visual representation can include one or more graphical objects, each formatted according to a respective data visualization format and containing graphical elements (such as lines, blocks, circles, text, and the like). A data visualization format defines type(s), arrangement(s), and/or attribute(s) of the graphical visual elements. Simply as an illustration, a data visualization format can be one of a chart format, a table format, a plot format, a KPI format, treeman format, a geochart format, and similar formats.

An example database, as shown in FIG. 2, can comprise a number of data tables (Tables 1-5). Each data table can contain data values of a number of data variables. For example, in Table 1 each data record contains data values of the data variables “Product,” “Price,” and “Part.” If there is no specific value in a field of the data record, this field is considered to hold a NULL-value. Similarly, in Table 2 each data record contains values of the variables “Date,” “Client,” “Product,” and “Number.” In Table 3 each data record contains values of variable “Date” as “Year,” “Month” and “Day.” In Table 4 each data record contains values of variables “Client” and “Country,” and in Table 5 each data record contains values of variables “Country,” “Capital,” and “Population.” Typically, the data values are stored in the form of ASCII-coded strings, but can be stored in any form.

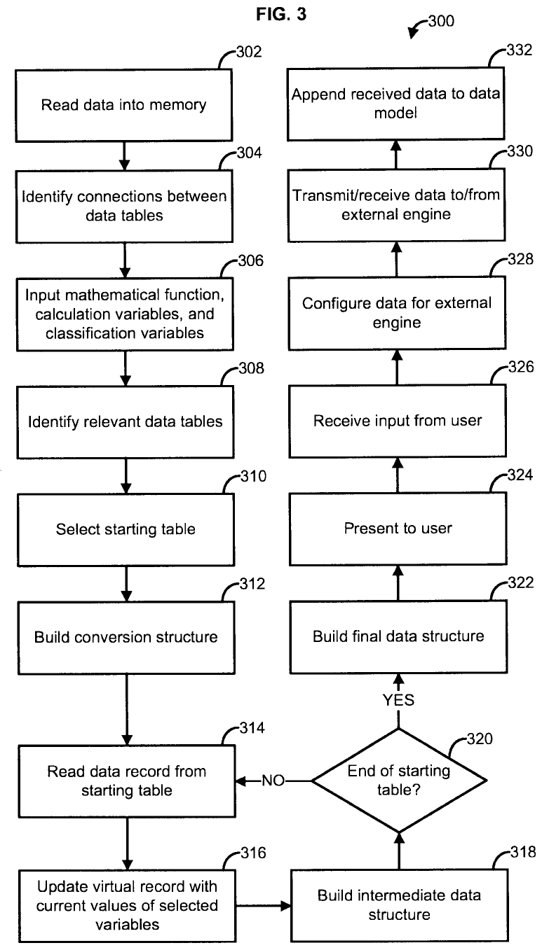

The methods disclosed herein can be implemented by means of a computer program as illustrated in a flowchart of a method 300 in FIG. 3. In a step 302, the program can read some or all data records in the database, for instance using a SELECT statement which selects all the tables of the database, e.g. Tables 1-5. In an aspect, the database can be read into primary memory of a computer.

To increase evaluation speed, each unique value of each data variable in said database can be assigned a different binary code and the data records can be stored in binary-coded form. This can be performed, for example, when the program first reads the data records from the database. For each input table, the following steps can be carried out. The column names, e.g. the variables, of the table can be read (e.g., successively). Every time a new data variable appears, a data structure can be instantiated for the new data variable. An internal table structure can be instantiated to contain some or all the data records in binary form, whereupon the data records can be read (e.g., successively) and binary-coded. For each data value, the data structure of the corresponding data variable can be checked to establish if the value has previously been assigned a binary code. If so, that binary code can be inserted in the proper place in the above-mentioned table structure. If not, the data value can be added to the data structure and assigned a new binary code, for example the next binary code in ascending order, before being inserted in the table structure. In other words, for each data variable, a unique binary code can be assigned to each unique data value.

After having read some or all data records in the database, the program can analyze the database in a step 304 to identify all connections between the data tables. A connection between two data tables means that these data tables have one variable in common. In an aspect, step 304 can comprise generation of one or more bidirectional table indexes and one or more bidirectional associative indexes. In an aspect, generation of one or more bidirectional table indexes and one or more bidirectional associative indexes can comprise a separate step. In another aspect, generation of one or more bidirectional table indexes and one or more bidirectional associative indexes can be on demand. After the analysis, all data tables are virtually connected. In FIG. 2, such virtual connections are illustrated by double ended arrows. The virtually connected data tables can form at least one so-called “snowflake structure,” a branching data structure in which there is one and only one connecting path between any two data tables in the database. Thus, a snowflake structure does not contain any loops. If loops do occur among the virtually connected data tables, e.g. if two tables have more than one variable in common, a snowflake structure can in some cases still be formed by means of special algorithms known in the art for resolving such loops.

After this initial analysis, the user can explore the database. In doing so, the user defines in a step 306 a mathematical function, which could be a combination of mathematical expressions. Assume that the user wants to extract the total sales per year and client from the database in FIG. 2. The user defines a corresponding mathematical function “SUM (x*y)”, and selects the calculation variables to be included in this function: “Price” and “Number.” The user also selects the classification variables: “Client” and “Year.”

The computer program then identifies in a step 308 all relevant data tables, e.g. all data tables containing any one of the selected calculation and classification variables, such data tables being denoted boundary tables, as well as intermediate data tables in the connecting path(s) between these boundary tables in the snowflake structure, such data tables being denoted connecting tables. There are no connecting tables in the present example. In an aspect, one or more bidirectional table indexes and one or more bidirectional associative indexes can be accessed as part of step 308.

In the present example, all occurrences of every value, e.g. frequency data, of the selected calculation variables can be included for evaluation of the mathematical function. In FIG. 2, the selected variables (“Price,” “Number”) can require such frequency data. Now, a subset (B) can be defined that includes all boundary tables (Tables 1-2) containing such calculation variables and any connecting tables between such boundary tables in the snowflake structure. It should be noted that the frequency requirement of a particular variable is determined by the mathematical expression in which it is included. Determination of an average or a median calls for frequency information. In general, the same is true for determination of a sum, whereas determination of a maximum or a minimum does not require frequency data of the calculation variables. It can also be noted that classification variables in general do not require frequency data.

Then, a starting table can be selected in a step 310, for example, among the data tables within subset (B). In an aspect, the starting table can be the data table with the largest number of data records in this subset. In FIG. 2, Table 2 can be selected as the starting table. Thus, the starting table contains selected variables (“Client,” “Number”), and connecting variables (“Date,” “Product”). These connecting variables link the starting table (Table 2) to the boundary tables (Tables 1 and 3).

Thereafter, a conversion structure can be built in a step 312. This conversion structure can be used for translating each value of each connecting variable (“Date,” “Product”) in the starting table (Table 2) into a value of a corresponding selected variable (“Year,” “Price”) in the boundary tables (Table 3 and 1, respectively). A table of the conversion structure can be built by successively reading data records of Table 3 and creating a link between each unique value of the connecting variable (“Date”) and a corresponding value of the selected variable (“Year”). It can be noted that there is no link from value 4 (“Date: 1999 Jan. 12”), since this value is not included in the boundary table. Similarly, a further table of the conversion structure can be built by successively reading data records of Table 1 and creating a link between each unique value of the connecting variable (“Product”) and a corresponding value of the selected variable (“Price”). In this example, value 2 (“Product: Toothpaste”) is linked to two values of the selected variable (“Price: 6.5”), since this connection occurs twice in the boundary table. Thus, frequency data can be included in the conversion structure. Also note that there is no link from value 3 (“Product: Shampoo”).

When the conversion structure has been built, a virtual data record can be created. Such a virtual data record accommodates all selected variables (“Client,” “Year,” “Price,” “Number”) in the database. In building the virtual data record, a data record is read in a step 314 from the starting table (Table 2). Then, the value of each selected variable (“Client”, “Number”) in the current data record of the starting table can be incorporated in the virtual data record in a step 316. Also, by using the conversion structure each value of each connecting variable (“Date”, “Product”) in the current data record of the starting table can be converted into a value of a corresponding selected variable (“Year”, “Price”), this value also being incorporated in the virtual data record.

In a step 318 the virtual data record can be used to build an intermediate data structure. Each data record of the intermediate data structure can accommodate each selected classification variable (dimension) and an aggregation field for each mathematical expression implied by the mathematical function. The intermediate data structure can be built based on the values of the selected variables in the virtual data record. Thus, each mathematical expression can be evaluated based on one or more values of one or more relevant calculation variables in the virtual data record, and the result can be aggregated in the appropriate aggregation field based on the combination of current values of the classification variables (“Client,” “Year”).

The above procedure can be repeated for one or more additional (e.g., all) data records of the starting table. In a step 320 it can be checked whether the end of the starting table has been reached. If not, the process can be repeated from step 314 and further data records can be read from the starting table. Thus, an intermediate data structure can be built by successively reading data records of the starting table, by incorporating the current values of the selected variables in a virtual data record, and by evaluating each mathematical expression based on the content of the virtual data record. If the current combination of values of classification variables in the virtual data record is new, a new data record can be created in the intermediate data structure to hold the result of the evaluation. Otherwise, the appropriate data record is rapidly found, and the result of the evaluation is aggregated in the aggregation field.

Thus, data records can be added to the intermediate data structure as the starting table is traversed. The intermediate data structure can be a data table associated with an efficient index system, such as an AVL or a hash structure. The aggregation field can be implemented as a summation register, in which the result of the evaluated mathematical expression is accumulated.

In some aspects, e.g. when evaluating a median, the aggregation field can be implemented to hold all individual results for a unique combination of values of the specified classification variables. It should be noted that only one virtual data record is needed in the procedure of building the intermediate data structure from the starting table. Thus, the content of the virtual data record can be updated for each data record of the starting table. This can minimize the memory requirement in executing the computer program.

After traversing the starting table, the intermediate data structure can contain a plurality of data records. If the intermediate data structure accommodates more than two classification variables, the intermediate data structure can, for each eliminated classification variable, contain the evaluated results aggregated over all values of this classification variable for each unique combination of values of remaining classification variables.

When the intermediate data structure has been built, a final data structure, e.g., a multidimensional cube, as shown in non-binary notation in Table 6 of FIG. 4, can be created in a step 322 by evaluating the mathematical function (“SUM (x*y)”) based on the results of the mathematical expression (“x*y”) contained in the intermediate data structure. In doing so, the results in the aggregation fields for each unique combination of values of the classification variables can be combined. In the example, the creation of the final data structure is straightforward, due to the trivial nature of the present mathematical function. The content of the final data structure can be presented to the user, for example in a two-dimensional table, in a step 324, as shown in Table 7 of FIG. 4. Alternatively, if the final data structure contains many dimensions, the data can be presented in a pivot table, in which the user can interactively move up and down in dimensions, as is well known in the art. At step 326, input from the user can be received. For example, input form the user can be a selection and/or de-selection of the presented results.

Optionally, input from the user at step 326 can comprise a request for external processing. In an aspect, the user can be presented with an option to select one or more external engines to use for the external processing. Optionally, at step 328, data underlying the user selection can be configured (e.g., formatted) for use by an external engine. Optionally, at step 330, the data can be transmitted to the external engine for processing and the processed data can be received. The received data can undergo one or more checks to confirm that the received data is in a form that can be appended to the data model. For example, one or more of an integrity check, a format check, a cardinality check, combinations thereof, and the like. Optionally, at step 332, processed data can be received from the external engine and can be appended to the data model as described herein. In an aspect, the received data can have a lifespan that controls how long the received data persists with the data model. For example, the received data can be incorporated into the data model in a manner that enables a user to retrieve the received data at another time/session. In another example, the received data can persist only for the current session, making the received data unavailable in a future session.

FIG. 5A shows how a selection 50 operates on a scope 52 of presented data to generate a data subset 54. The data subset 54 can form a state space, which is based on a selection state given by the selection 50. In an aspect, the selection state (or “user state”) can be defined by a user clicking on list boxes and graphs in a user interface of an application. An application can be designed to host a number of graphical objects (charts, tables, etc.) that evaluate one or more mathematical functions (also referred to as an “expression”) on the data subset 54 for one or more dimensions (classification variables). The result of this evaluation creates a chart result 56 which can be a multidimensional cube which can be visualized in one or more of the graphical objects.

The application can permit a user to explore the scope 52 by making different selections, by clicking on graphical objects to select variables, which causes the chart result 56 to change. At every time instant during the exploration, there exists a current state space, which can be associated with a current selection state that is operated on the scope 52 (which always remains the same).

As illustrated in FIG. 5A, when a user makes a selection, the inference engine 18 calculates a data subset. Also, an identifier ID1 for the selection together with the scope can be generated based on the filters in the selection and the scope. Subsequently, an identifier ID2 for the data subset is generated based on the data subset definition, for example a bit sequence that defines the content of the data subset. ID2 can be put into a cache using ID1 as a lookup identifier. Likewise, the data subset definition can be put in the cache using ID2 as a lookup identifier.

As shown in FIG. 5A, a chart calculation in a calculation/chart engine 58 takes place in a similar way. Here, there are two information sets: the data subset 54 and relevant chart properties 60. The latter can be, but not restricted to, a mathematical function together with calculation variables and classification variables (dimensions). Both of these information sets can be used to calculate the chart result 56, and both of these information sets can be also used to generate identifier ID3 for the input to the chart calculation. ID2 can be generated already in the previous step, and ID3 can be generated as the first step in the chart calculation procedure.

The identifier ID3 can be formed from ID2 and the relevant chart properties. ID3 can be seen as an identifier for a specific chart generation instance, which can include all information needed to calculate a specific chart result. In addition, a chart result identifier ID4 can be created from the chart result definition, for example a bit sequence that defines the chart result 56. ID4 can be put in the cache using ID3 as a lookup identifier. Likewise, the chart result definition can be put in the cache using ID4 as a lookup identifier.

Optionally, further calculations, transforming, and/or processing can be included through an extension engine 62. Optionally, associated results from the inference engine 18 and further computed by hypercube computation in said calculation/chart engine 58 can be coupled to an external engine 64 that can comprise one or more data processing applications (e.g., simulation applications, statistical applications, mathematical computation applications, database applications, combinations thereof, and the like). Context of a data model processed by the inference engine 18 can comprise a tuple or tuples of values defined by dimensions and expressions computed by hypercube routines. Data can be exchanged through an interface 66.

The associated results coupled to the external engine 64 can be intermediate. Further results that can be final hypercube results can also be received from the external engine 64. Further results can be fed back to be included in the Data/Scope 52 and enrich the data model. The further results can also be rendered directly to the user in the chart result 56. Data received from and computed by the external engine 64 can be used for further associative discovery.

Each of the data elements of the database shown in Tables 1-5 of FIG. 2 has a data element type and a data element value (for example “Client” is the data element type and “Nisse” is the data element value). Multiple records can be stored in different database structures such as data cubes, data arrays, data strings, flat files, lists, vectors, and the like; and the number of database structures can be greater than or equal to one and can comprise multiple types and combinations of database structures. While these and other database structures can be used with, and as part of, the methods and systems disclosed, the remaining description will refer to tables, vectors, strings and data cubes solely for convenience.

Additional database structures can be included within the database illustrated as an example herein, with such structures including additional information pertinent to the database such as, in the case of products for example; color, optional packages, etc. Each table can comprise a header row which can identify the various data element types, often referred to as the dimensions or the fields, that are included within the table. Each table can also have one or more additional rows which comprise the various records making up the table. Each of the rows can contain data element values (including null) for the various data element types comprising the record.

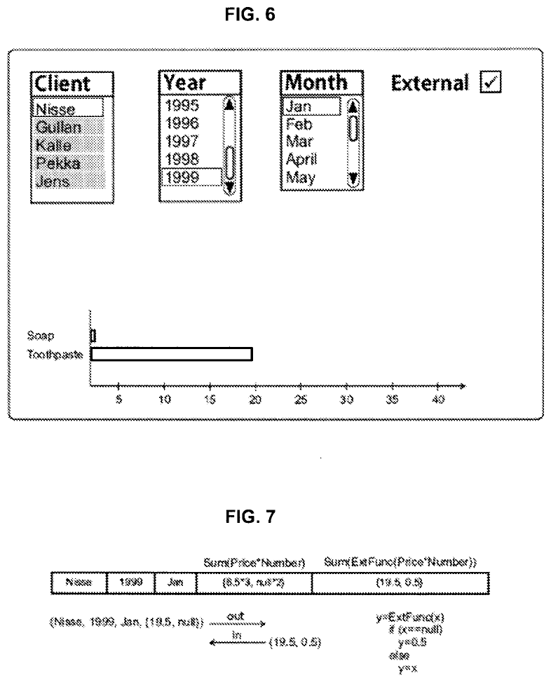

The database as referred to in Tables 1-5 of FIG. 2 can be queried by specifying the data element types and data element values of interest and by further specifying any functions to apply to the data contained within the specified data element types of the database. The functions which can be used within a query can include, for example, expressions using statistics, sub-queries, filters, mathematical formulas, and the like, to help the user to locate and/or calculate the specific information wanted from the database. Once located and/or calculated, the results of a query can be displayed to the user with various visualization techniques and objects such as list boxes of a user interface illustrated in FIG. 6.

The graphical objects (or visual representations) can be substantially any display or output type including graphs, charts, trees, multi-dimensional depictions, images (computer generated or digital captures), video/audio displays describing the data, hybrid presentations where output is segmented into multiple display areas having different data analysis in each area and so forth. A user can select one or more default visual representations; however, a subsequent visual representation can be generated on the basis of further analysis and subsequent dynamic selection of the most suitable form for the data.

In an aspect, a user can select a data point and a visualization component can instantaneously filter and re-aggregate other fields and corresponding visual representations based on the user's selection. In an aspect, the filtering and re-aggregation can be completed without querying a database. In an aspect, a visual representation can be presented to a user with color schemes applied meaningfully. For example, a user selection can be highlighted in green, datasets related to the selection can be highlighted in white, and unrelated data can be highlighted in gray. A meaningful application of a color scheme provides an intuitive navigation interface in the state space.

The result of a standard query can be a smaller subset of the data within the database, or a result set, which is comprised of the records, and more specifically, the data element types and data element values within those records, along with any calculated functions, that match the specified query. For example, as indicated in FIG. 6, the data element value “Nisse” can be specified as a query or filtering criteria as indicated by a frame in the “Client” header row. In some aspects, the selected element can be highlighted in green. By specifically selecting “Nisse,” other data element values in this row are excluded as shown by gray areas. Further, “Year” “1999” and “Month” “Jan” are selected in a similar way.

Optionally, in this application, external processing can also be requested by ticking “External” in the user interface of FIG. 6. Data as shown in FIG. 7 can be exchanged with an External engine 64 through the interface 66 of FIG. 5A. In addition to evaluating the mathematical function (“SUM (Price*Number)”) based on the results of the mathematical expression (“Price*Number”) contained in the intermediate data structure the mathematical function (“SUM (ExtFunc(Price*Number))”) can be evaluated. Data sent out are (Nisse, 1999, Jan, {19.5, null}). In this case the external engine 64 can process data in accordance with the formula

```
if (x==null)
  y=0.5
else
  y=x
```

as shown in in FIG. 7. The result input through the interface 66 will be (19.5, 0.5) as reflected in the graphical presentation in FIG. 6.

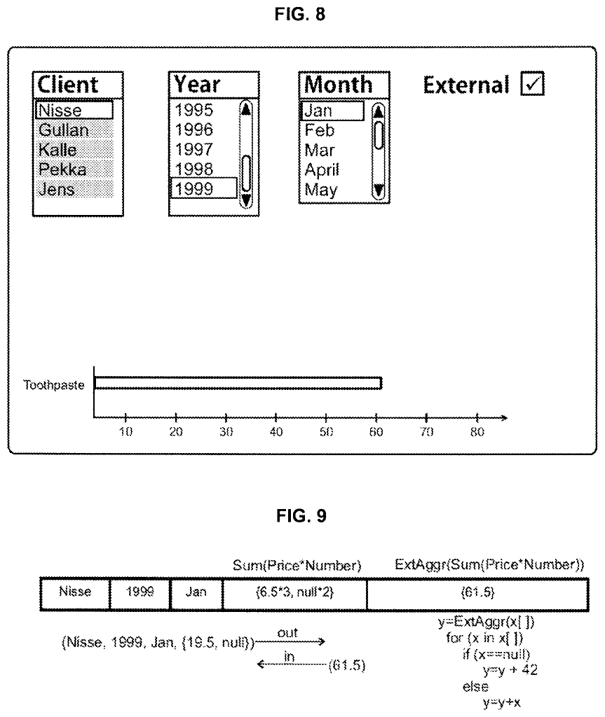

In a further aspect, external processing can also be optionally requested by ticking “External” in a box as shown in FIG. 8. Data as shown in FIG. 9 can be exchanged with an external engine 64 through the Interface 66 of FIG. 5A. In addition to evaluating the mathematical function (“SUM(Price*Number)”) based on the results of the mathematical expression (“Price*Number”) contained in the intermediate data structure the mathematical function

SUM(ExtFunc(Price*Number))
can be evaluated. Data sent out are (Nisse, 1999, Jan, {19.5, null}). In this case the external engine 64 will process data in accordance with Function (1) as shown below and in FIG. 9. The result input through the Interface 66 will be (61.5) as reflected in the graphical presentation in FIG. 8.

```
y=ExtAggr(x[ ])
  for (x in x[ ])
    if (x==null)
      y=y + 42
    else
      y=y+x
Function (1)
```

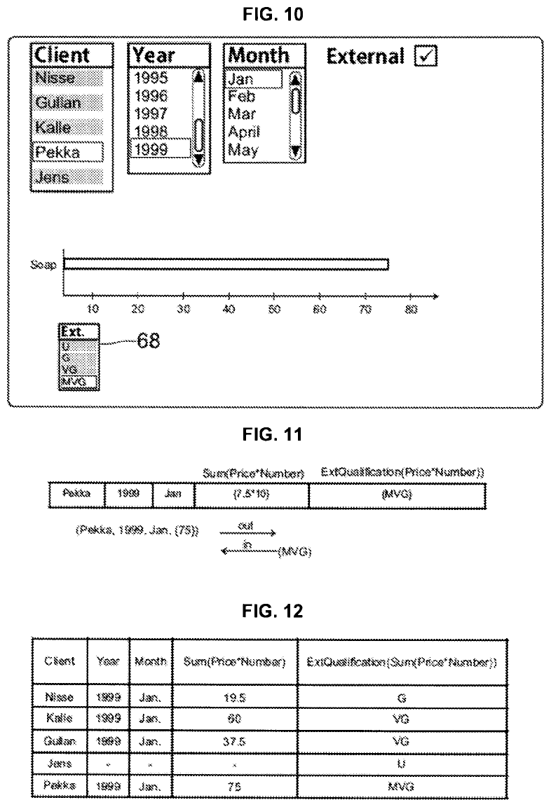

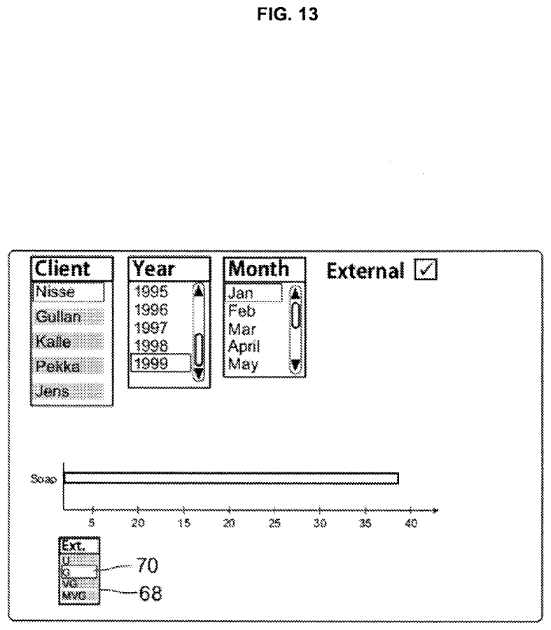

A further optional embodiment is shown in FIG. 10 and FIG. 11. The same basic data as in previous examples apply. A user selects “Pekka,” “1999,” “Jan,” and “External.” By selecting “External,” already determined and associated results are coupled to the external engine 64. Feedback data from the external engine 64 based on an external computation, ExtQualification(Sum(Price*Number)), as shown in FIG. 13 will be the information “MVG.” This information can be fed back to the logical inference engine 18. The information can also be fed back to the graphical objects of FIG. 10 and as a result a qualification table 68 will highlight “MVG” (illustrated with a frame in FIG. 10). Other values (U, G, and VG) are shown in gray areas. The result input through the Interface 66 will be Soap with a value of 75 as reflected in the graphical presentation (bar chart) of FIG. 10. FIG. 11 is a schematic representation of data exchanged with an external engine based on selections in FIG. 10. FIG. 12 is a table showing results from computations based on different selections in the presentation of FIG. 10.

Should a user instead select “Gullan,” “1999,” “Jan,” and “External,” the feedback signal would include “VG” based on the content shown in qualification table 68. The computations actually performed in the external engine 64 are not shown or indicated, since they are not relevant to the inference engine.

In FIG. 13 a user has selected “G” as depicted by 70 in the qualification table 68. As a result information fed back from the external engine 64 to the extension engine 62 and further to the inference engine 18 the following information will be highlighted: “Nisse,” “1999,” and “Jan” as shown in FIG. 13. Furthermore, the result produced will be Soap 37.5 as reflected in the graphical presentation (bar chart) of FIG. 13.

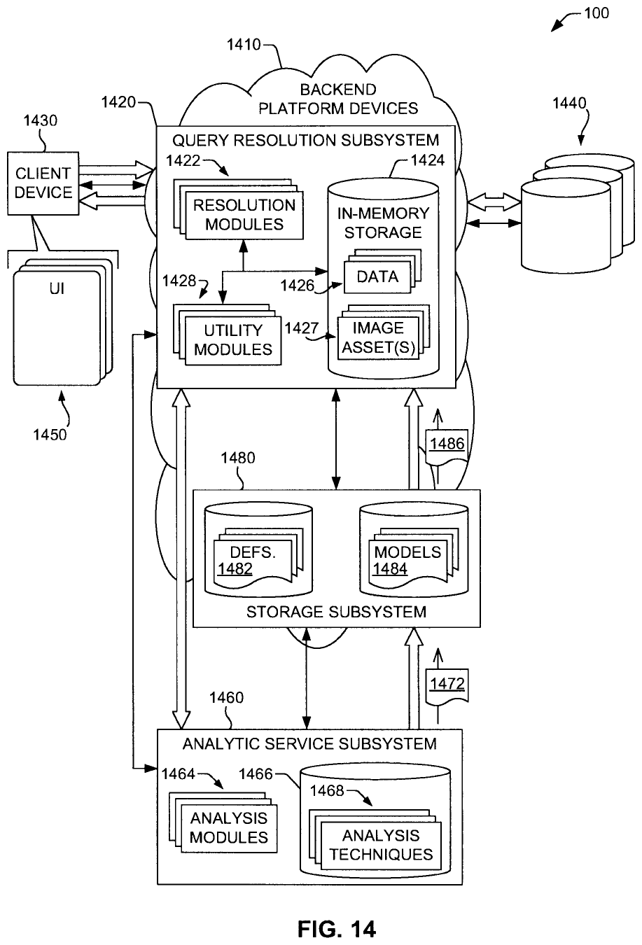

FIG. 14 shows an example of an operating environment 1400 for generation of insights, in accordance with one or more embodiments of this disclosure. The operating environment 1400 includes backend platform devices 1410 that constitute a platform for analysis of data. To at least that end, the backend platform devices 1410 include a query resolution subsystem 1420 that is functionally coupled to a client device 1430. A gateway component (not depicted in FIG. 14) within the backend platform devices 1410 can functionally couple, at least partially, the query resolution subsystem 1420 and the client device 1430. Such a coupling can be mediated, or otherwise permitted, by upstream link(s) and downstream link(s) and other network elements that permit communication between the user device 1430 and the gateway component. Such links can be wireline link(s) or wireless link(s), or a combination of both. A double-headed arrow connecting the user device 1430 and the backend platform devices 1410 represents those links and network elements. The client device 1430 that can execute a client application (not depicted in FIG. 14) to analyze data in accordance with aspects described herein. The client application can be retained in one or several memory devices (not depicted in FIG. 14) and can be embodied in a web browser, a mobile application, or similar software application. The client device 1430 can be embodied in, for example, a personal computer (PC), a laptop computer, a tablet computer, a smartphone, or similar device.

As part of analyzing data, the query resolution subsystem 1420 can receive a client query (or simply a “query”; not depicted in FIG. 14) via the client device 1430. The phrase “client query” as used herein relates to the discussion above regarding FIG. 5A and how a selection 50 operates on a scope 52 of presented data to generate a data subset 54, which may form a state space that may be based on a selection state given by the selection 50. As described herein, a selection state (or a “user state”) may be defined by a user clicking on list boxes and graphs within a user interface (UI) of an application executing on the client device 1430. The application/UI may comprise a number of graphical objects (e.g., charts, tables, etc.) that evaluate one or more mathematical functions (also referred to as “expressions”) on a data subset (e.g., the data subset 54) for one or more dimensions (e.g., classification variables), metrics, etc.

The client query can include one or more query criteria, including in some cases a filtering criterion. The query resolution subsystem 1420 can receive the client query by means of the gateway component. In addition, the query resolution subsystem 1420 can be functionally coupled to multiple data source devices 1440 containing source data. One or multiple connector components (not depicted in FIG. 14) can functionally couple the query resolution subsystem 1420 and at least one device of the multiple data source devices 1440. Each one of the connector component(s) serves as a gateway for data from a source device of the multiple data source devices 1440 to be transported to the query resolution subsystem 1420. Such a coupling can be mediated, or otherwise permitted, by upstream link(s) and downstream link(s) and other network elements that permit communication between the connector component(s) and at least one of the data source devices 1440. Such links can be wireline link(s) or wireless link(s), or a combination of both. A double-headed arrow connecting the data source devices 1440 and the backend platform devices 1410 represents those links and network elements. That double-headed open arrow has a single-segment shaft.

The query resolution subsystem 1420 includes multiple resolution modules 1422 that, individually or collectively, can analyze source data in response to the client query. A first resolution module of the multiple resolution modules 1422 can access source data from the multiple data source devices 1440. A second resolution module of the multiple resolution modules 1422 can determine a subset of the accessed source data satisfying the client query.

A third resolution module of the multiple resolution modules 1422 can generate dashboard data 1426 based on the client query and the subset of the accessed source data. The third resolution module (or, in some cases, another one of the multiple resolution modules 1422) can retain the dashboard data 1426 within in-memory storage 1424. The in-memory storage 1424 can have a low latency of the order of 1 ms or less, which latency renders the in-memory storage 1424 adequate for fast access, including real-time access. Latencies of the order of 10 ms also may be adequate. The in-memory storage 1424 thus embodies a performant cache for storage and readout of data. In one example, the in-memory storage 1424 can be embodied in an in-memory key-value cache having low latency.

The dashboard data 1426 can include source data (also referred to as original data) satisfying the client query, derivative data obtained from that source data, or a combination of that source data and the derivative data. The derivative data results from operating on the source data satisfying the query. Although one of the many operations that can be applied to source data can be a derivative of order n (or n-th derivative; such as first derivative, second derivative, etc.) the implementation of other operations also results in derivative data. Examples of those other operations include linear algebra operations, transformation (or normalization) operations, operations involved in searching an extremum, and the like.

The dashboard data 1426 also can include imaging data and imaging metadata that, individually or collectively, define a visual representation of original data and derivative data. The visual representation can include one or more UI objects, including one or more graphical objects and/or other indicia (e.g., signs, indications, or other markings). At least one of the UI object(s) can represent a respective portion of the accessed source data and/or a respective portion of the derivative data. The imaging data can define pixel content of pixels that constitute the visual representation. In some cases, rather than being generated by such a third resolution module of the multiple resolution modules 1422, at least a portion of the imaging data can be based on input data received by one or more of the resolution modules 1422. The imaging metadata can define visualization formats for presentation of respective ones of the UI object(s) at the client device 1430. As such, a graphical object that may be included in the UI object(s) is formatted according to a particular data visualization format, and contains graphical elements (such as lines, blocks, circles or other types of symbols, text, and similar markings) that convey the data forming part of the visual representation. That particular data visualization format defines type(s), arrangement(s), and/or attribute(s) of the graphical visual elements. The imaging metadata also can define a layout of the UI object(s) included in the visual representation. Such a layout includes an arrangement of areas corresponding to respective graphical objects that may be included in the visual representation. Each area within the arrangement of areas has a defined shape, a defined size, and a defined placement within a viewport defined as part of the layout. Hence, the layout can convey relative visualization weight (or emphasis) ascribed to the graphical objects that may present in the visual representation. In some cases, rather than being generated by such a third resolution module of the multiple resolution modules 1422, the imaging metadata can be based on input data received by one or more of the resolution modules 1422. The input data can be received from the client device 1430.

Accordingly, at least one of the resolution modules 1422 can generate an image asset 1427 corresponding to a visual representation of source data and derivative data (e.g., as defined by imaging data and/or imaging metadata). The image asset can be retained within the in-memory storage 1424. The image asset 1427 may be embodied as a digital image and can be formatted according to numerous formatting schemes for digital images. In one example, the image asset 1427 can be formatted according to the Joint Photographic Experts Group (JPEG) standard. Examples of other formatting schemes include Portable Document Format (.PDF), Portable Network Graphics (.PNG) format, and Adobe® Photoshop® (.PSD) format.

A fourth resolution module of the multiple resolution modules 1422 can cause the client device 1430 to present at least a portion of the dashboard data 1426. Causing presentation of such data can include generating a data structure that controls visualization of at least the portion of the dashboard data 1426 at a user interface. The data structure can include at least the portion of the dashboard data 1426, in some cases. The fourth resolution module of the multiple resolution modules 1422 can send at least a portion of the dashboard data 1426 to the client device 1430 by means of the gateway component (not depicted in FIG. 14) that is included in at least one of the backend platform devices 1410. In some cases, such a portion of the dashboard data can be sent in the data structure. Upon or after receiving at least the portion of the dashboard data 1426 (or such a data structure), the client device 1430 can present one or more user interfaces 1450 (UIs 1450). Each UI of the UI(s) 1450 includes one or multiple UI objects (e.g., charts, tables, plots, and similar objects) conveying, individually and/or in combination, the received dashboard data. Each UI object included in the UI can constitute a data insight corresponding to the dashboard data.

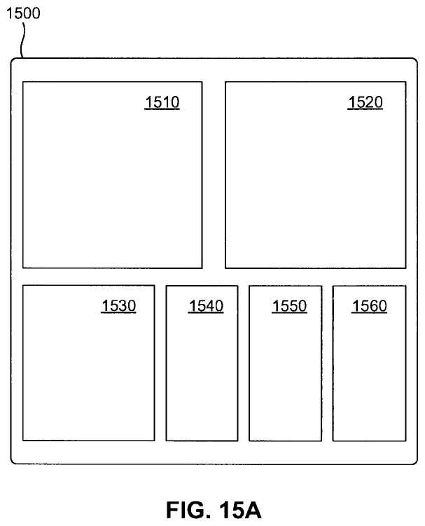

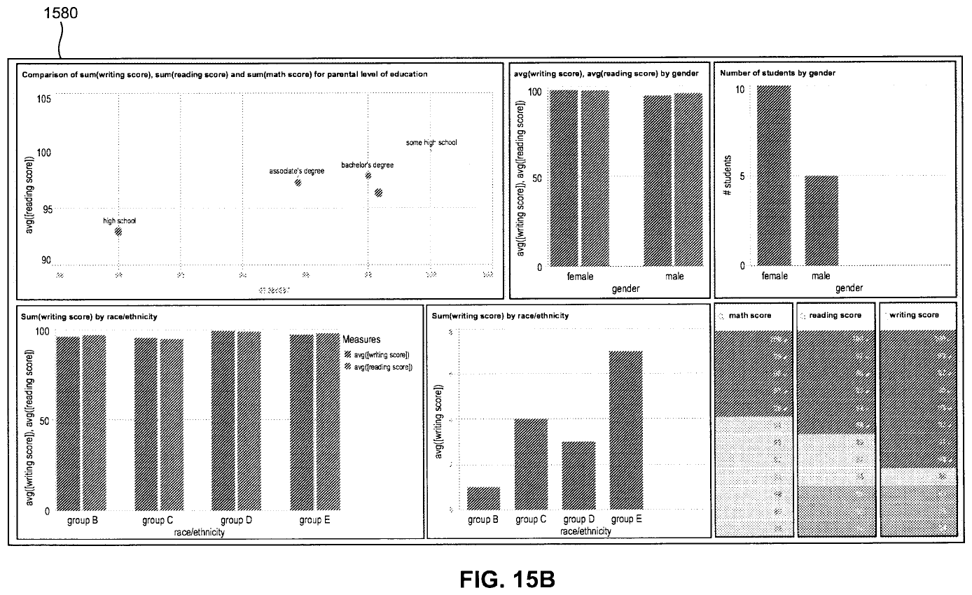

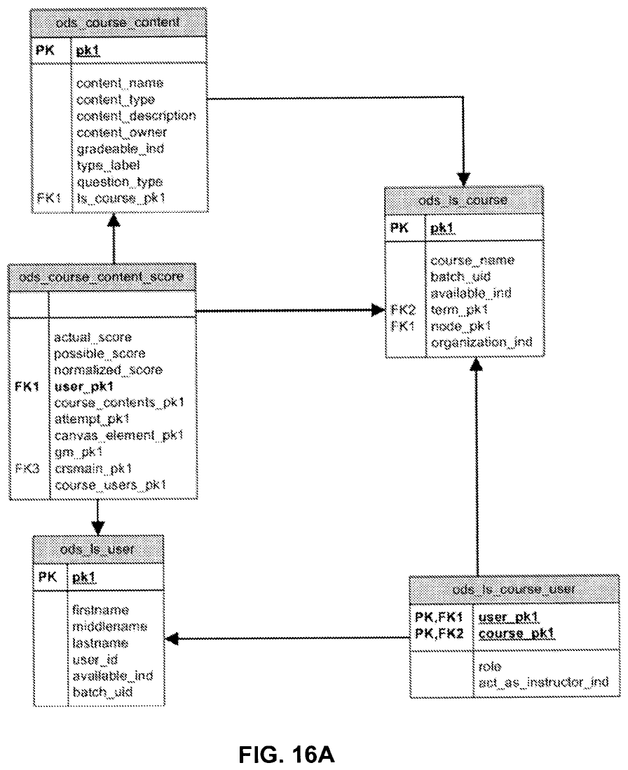

Simply as an illustration, the schematic UI 1500 shown in FIG. 15A is an example of a user interface (UI) that conveys data insights corresponding to a client query associated with a particular definition. The UI 1500 includes multiple graphs and multiple tables. Specifically, the UI 1500 includes a first graph 1510, a second graph 1520, and a third graph 1530. Additionally, the UI 1500 also includes a first column-table 1540, a second column-table 1550, and a third column-table 1560. A column-table refers to a table having a single column corresponding to a field (or a dimension), where the single column includes one or more records. In some cases, the column-table can include multiple records, where at least one of the multiple records can be color coded according to a defined schema. For example, a record that satisfies the filtering criterion can be highlighted in green, records related to the filtering criterion can be highlighted in white, and unrelated records can be highlighted in gray (see FIG. 15B for an example). Color coding a record can visually and conspicuously indicate whether the record satisfies a filtering criterion included in the client query. Indeed, as mentioned, a meaningful application of a color scheme provides an intuitive navigation interface in the state space.

As a further illustration, the example UI 1580 shown in FIG. 15B is an example of a dashboard (e.g., a user interface) that conveys data insights corresponding to a client query associated with a particular definition of an entity. In one example, the client query can be “who is a good student” and the entity can be “good student.”

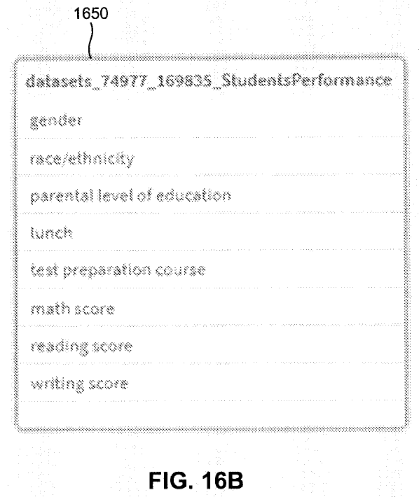

With further reference to FIG. 14, an analytic service subsystem 1460 can be functionally coupled to the query resolution subsystem 1420. Such a coupling can be provided by a network architecture (represented by a double-headed arrow connective those subsystems). Although the analytic service subsystem 1460 is shown as being external to the backend platform devices 1410, the disclosure is not limited in that respect and in some embodiments, the analytic service subsystem 1460 can be part of the backend platform devices 1410. The analytic service subsystem 1460 can include multiple analysis modules 1464 that, individually or in combination, can implement multiple analysis techniques 1468. In some cases, the multiple analysis techniques 1468 can be retained in one or multiple memory devices 1466 (which can be referred to as repository 1466). The disclosure, however, is not limited in that respect and the analysis techniques 1468 can be retained in other storage devices or subsystems. By implementing one or multiple particular analysis techniques of the analysis techniques 1468, the analytic service subsystem 1460 can analyze dashboard data 1426. Analyzing the dashboard data 1426 can include generating derivative data based on, for example, original data present in the dashboard data 1426. The derivative data can be generated using associative analysis in accordance with aspects of this disclosure. The associative analysis need not be limited to a particular data model used to generate the dashboard data 1426. Indeed, the analytic service subsystem 1460 can generate meta models defining a subspace of data models. For purposes of illustration, the meta models are data models representing associations besides the particular data model. That is, a meta model can be a data model representing an association that is different from the association conveyed by the particular data model. The analytic service subsystem 1460 can generate a meta model in various ways. For example, the meta model can be generated by randomly creating a configuration of associations among fields (or dimensions) contained in a defined group of tables that form part of the particular data model. Such a configuration of associations can be referred to as a realization of associations. In addition, or in some cases, the analytic service subsystem 1460 can determine one or more other tables besides those that form part of the particular data model. As an example, the other tables can be determined randomly (according to a defined probability distribution, for example) or based on a selection criterion. The other table(s) can be determined, and obtained, using data present in the source devices 1440. In some cases, at least one of the analysis modules 1464 can determine the other table(s). In other cases, the analytic service subsystem 1460 can direct a utility module of the utility modules 1428 to determine the other table(s). The utility modules 1428, individually or in a particular combination, can provide one or multiple services to the analytic service subsystem 1460. As such, determining such tables can be an example of such service(s). Combined with tables present in the particular data model or the other table(s), such a realization defines a graph (such as a tree structure) having edges representing respective associations and nodes representing a table. Simply as an illustration an example of such a realization is shown in FIG. 16A, where each association is represented by an arrow. Further, the analytic service subsystem 1460 can randomly create other configurations of associations among those fields (or dimensions), thus generating an ensemble of configurations. Each configuration (or realization) in that ensemble constitutes a meta model. In addition, or in some cases, the analytics service subsystem 1460 can generate multiple data views using metrics and/or aggregations besides those involved in the generation of the dashboard data 1426. The multiple data views and meta models can provide derivative dataset(s) based on the dashboard data 1426.

As part of the analysis of the dashboard data 1426 and derivative dataset(s), one or more of the analysis modules 1464 can operate on the dashboard data 1426 or derivative dataset(s), or a combination thereof, by implementing the particular analysis technique(s) of the analysis techniques 1468 by means of at least one utility module of the utility modules 1428. At least one of the particular technique(s) can include determining a solution to an optimization problem with respect to a cost/objective function based on a subspace of model functions and one or a combination of the dashboard data 1426 or derivative dataset(s). The model functions can be referred to as basis functions and can have varying degrees of complexity. Examples of model functions include polynomial functions (up to order m (a natural number)); radial functions (such as Gaussian functions or Bessel functions); Fourier basis (either sine functions or cosine functions, for example); rectified linear unit (ReLU) functions; sigmoid functions; and similar. The solution to the optimization problem can define a set of parameters and one or more procedures, each procedure of the procedure(s) being cast as an expansion (or series) in terms of the model functions. At least a subset of the set of parameters can define a series of model functions for a procedure of the one or more procedure(s). To determine such a solution, the at least one of the analysis modules 1468 can implement an automated search of a group of model functions and associated parameters. The search can be implemented iteratively. The automated search may be unconstrained in some cases, where various types of model functions and groups thereof are traversed in order to determine the solution to the optimization problem. In some cases, the at least one of the analysis modules 1468 can implement evolutionary algorithms; Monte Carlo approaches; other approaches for automated selection of an algorithm (or a procedure) from a pool of algorithms, and the like.

Rather than obtaining and directly operating on the dashboard data 1426, the analytic service subsystem 1460 can cause or otherwise direct the at least one utility module to perform one or multiple operations on the dashboard data 1426 at the in-memory storage 1424. As mentioned, the utility models 1428, individually or in a particular combination, can provide one or multiple services to the analytic service subsystem 1460. Such operation(s) constitute the at least one of the analysis techniques 1468. In some example scenarios, the analytic service subsystem 1460 (via at least one of the analysis modules 1464, for example) can pass program code to the at least one utility module of the utility modules 1428, where the program code defines one or more of the operation(s). In response to receiving the program code, the at least one utility module can build (e.g., link and compile) the program code, and can then execute the built program code to operate on the dashboard data 1426. In some cases, the at least one utility module can apply one or more code templates to the program code and can them build the resulting program code instead of the received program code. Further, because the utility module(s) 1428 can implement such operations at the storage location of the data being operated on, time-consuming transport of data (e.g., I/O operations involved in the exchange of large amounts of data) can be mitigated or even avoided altogether. The storage location of the data being operated on can be the in-memory storage 1424 or another type of performant data storage. Therefore, in sharp contrast to existing technologies, one or multiple versions of analytic models can be computationally efficiently determined, without undue utilization of computing resources within the backend platform devices 1410.

Therefore, based on the analysis of the dashboard data 1426 and/or derivative data therefrom, the analytic service subsystem 1460 generates an analytic model 1472. The analytic model 1472 is a solution to the optimization problem described herein. The analytic model 1472 updates a definition of the entity. One or more definitions 1482 of the entity, and also other entities can be retained in one or more repositories within the storage subsystem 1480. More specifically, the analytic model 1472 synthetizes or otherwise represents a semantic meaning of the definition of the entity. The analytic model 1472 can constitute, or can include, a computer-operable object (COO) having a set of one or multiple numeric parameters and also having one or multiple procedures. A numeric parameter may comprise, for example, a numeric value associated with a metric and/or aggregation. Additionally, or in the alternative, a numeric parameter may comprise a value for a particular field or dimension associated with the metric and/or aggregation. At least a first procedure of the procedure(s) includes at least a subset of the set of one or more numeric parameters. That is, at least the first procedure can be parameterized in terms of at least one parameter of the set of one or more numeric parameters. The numeric parameter(s) and the procedure(s) collectively represent correlations present in the dashboard data 1426 and/or derivative data obtained from the dashboard data 1426. Those correlations can embody a mapping between the dashboard data 1426 and select fields and/or select dimensions, or both, defining a precursor definition of the entity. The select fields and/or select dimensions are part of a data model corresponding to the entity. The listing 1650 (FIG. 16B) shows an example of select fields defining a precursor entity. The example select fields are merely illustrative and include “gender;” “race/ethnicity,” “parental level of education,” “lunch” (a field that indicates a degree of food security—whether lunch is readily available, occasionally available, or scarcely available, for example), “test preparation course” (a field that indicates whether access (past or present) is available), “math score” (an average over a defined time interval, for example), “reading score” (an average over a defined time interval, for example), and “writing score” (an average over a defined time interval, for example).

The analytic service subsystem 1460 can send the analytic model 1472 to a storage subsystem 1480. The analytic service subsystem 1460 and the storage subsystem 1480 can be functionally coupled via a network architecture (represented by a double-headed arrow connective those subsystems). The storage subsystem 1480 can include other analytic models 1484. The analytic models 1484 can be retained within one or more repositories within the storage subsystem 1480. At least some of the analytic models 1484 may have been created in similar fashion as the analytic model 1472. Thus, each analytic model of the analytic models 1484 updates a definition of an entity, synthetizing/representing a semantic meaning of the definition of the entity within dashboard data. Each analytic model of the analytic models 1484 can constitute, or can include, a computer-operable object having a set of one or multiple numeric parameters and also having one or multiple procedures.

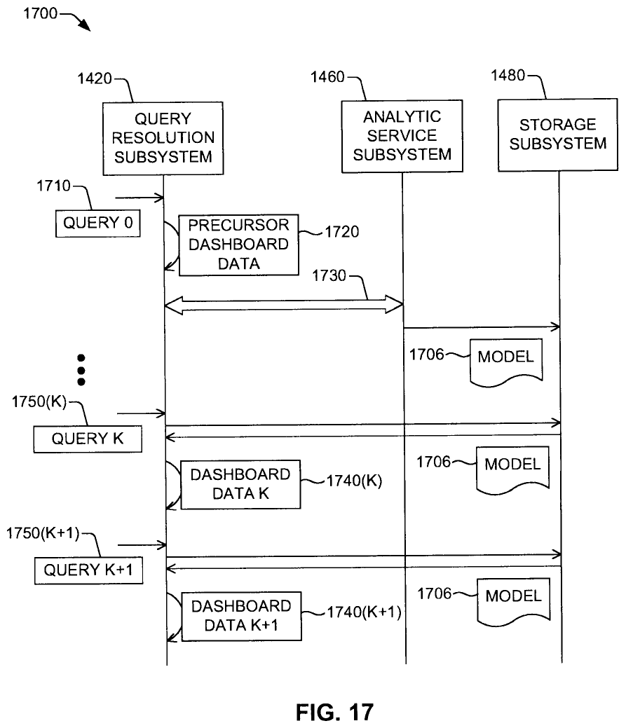

Regardless of the manner of generating an analytic model of the analytic models 1484, the analytic model can be used to mine for insights from data contained in the data source devices 1440. In one example, the analytic model can be analytic model 1486 and can be obtained by the query resolution subsystem 1420 to mine for such insights. FIG. 17 shows an example of a process flow for generation of insights using an analytic model 1706, in accordance with one or more embodiments of this disclosure. The analytic model 1706 can result from a precursor query 1710 (referred to as query 0 1710, simply for the sake of nomenclature). The query 0 1710 is referred as a precursor query because prior to processing that query, the analytic model 1706 has not been created. The query 0 1710 can include query criteria defining an entity (e.g., “good student”), and the analytic model 1706 updates the definition of the entity as is provided by the query criteria. The query criteria can dictate, for example, that a “good student” is any student having test scores that exceed respective threshold scores—e.g., average score in math assessments exceeding a first threshold score, average score in reading assessments exceeding a second threshold score, and average score in writing assessments exceeding a third threshold score.

The query resolution subsystem 1420 can receive the query 0 1710 and, in response, can generate precursor dashboard data 1720. The query resolution subsystem 1420 can retain the precursor dashboard data 1720 within the in-memory storage 1424 (FIG. 14). The analytic service subsystem 160 can analyze the precursor dashboard data 1720 to generate the analytic model 1706. More specifically, the analytic service subsystem 1460 can operate on precursor dashboard data 1720 by implementing an analysis technique 1730 by means of at least one utility module of the utility modules 128. Rather than obtaining and directly operating on the precursor dashboard data 1720, the analytic service subsystem 1460 can cause or otherwise direct the at least one utility module to perform one or multiple operations on the dashboard data. Such operation(s) constitute the analysis technique 1730. Implementation of the analysis technique 1730 yields the analytic model 1706.

After the analytic model 1706 has been generated, the query resolution subsystem 120 can receive one or multiple subsequent queries associated with the entity (e.g., “good student”). To resolve a subsequent query, the query resolution subsystem 1420 can obtain the analytic model 1706 and can then apply the analytic model to source data. As is illustrated in FIG. 17, the query resolution subsystem 1420 can receive a subsequent query K 1750(K). The index K is a natural number that serves as an index indicating that the subsequent query K is the K-th query received after the analytic model 1706 has been generated. In response to receiving the subsequent query K 1750(K), the query resolution subsystem 1420 can obtain the analytic model 1706 from the storage subsystem 1480. The query resolution subsystem 1420 can then resolve the subsequent query K 1750(K) by applying the analytic model 1706 to source data. Applying the analytic model can include executing a particular procedure with the source data as an argument, where the particular procedure is part of the analytic model Q 1706(Q). The procedure can be executed in numerous ways. For example, executing the procedure can include accessing a subset of the source data from an in-memory cache, and executing a task/utility process that operates on the subset of the source data. Resolving the subsequent query K 1750(K) can include generating dashboard data K 1740(K) satisfying the subsequent query K 1750(K).

In some cases, as is illustrated in FIG. 17, the query resolution subsystem 120 can further receive a next subsequent query K+1 1750(K+1). In response to receiving the next subsequent query K+1 1750(K+1), the query resolution subsystem 1420 can again obtain the model 1706 from the storage subsystem 180. The query resolution subsystem 1420 can then resolve the subsequent query K+1 1750(K+1) by again applying the analytic model 1706 to source data. Applying the analytic model can include executing a particular procedure with the source data as an argument, where the particular procedure is part of the analytic model Q 1706(Q). The procedure can be executed in numerous ways. For example, executing the procedure can include accessing a subset of the source data from an in-memory cache, and executing a task/utility process that operates on the subset of the source data. Resolving the subsequent query K+1 1750(K+1) can include generating dashboard data K 1740(K+1) satisfying the subsequent query K+1 1750(K+1). Accordingly, the analytic model 1706 can be fed back into the generation of data insights pertaining to the entity synthetized by the analytic model 1706.

Source data contained in the data source devices 1440 can change over time. Such a change can result in an updated data context that can yield updated data insights relative to prior data insights. An existing analytic model can thus be applied to current source data in order to update the analytic model, resulting in an updated version of analytic model and therefore, an updated definition of the entity corresponding to the analytic model.

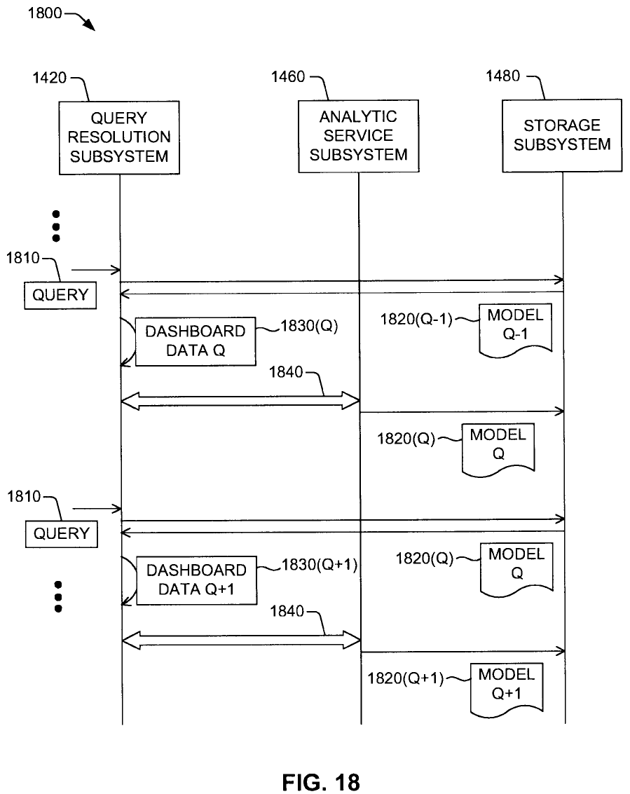

FIG. 18 shows an example of a process flow 1800 to generate versions of an analytic model corresponding to a particular entity (e.g., “good student” or “good electric vehicle”). The query resolution subsystem 1420 can receive a query 1810. In some cases, the query 1810 can be received in response to an update criterion being satisfied by source data present in the data source devices 1440. As an example, the update criterion can dictate that a particular time interval must elapse since a prior update in order to generate a new version of the analytic model. As another example, the update criterion can dictate that a defined amount of new source data has been added to the data source devices 1440. In addition, or in other cases, the new version of the analytic model can be generated on demand, and thus, the query 1810 can be received asynchronously relative to a prior time when the query 1810 was received.

In response to receiving the query 1810, the query resolution subsystem 120 can obtain a current analytic model Q−1 1820(Q−1). The analytic model Q−1 1820(Q−1) can be obtained from the storage subsystem 180, for example. Here, Q is a natural number that serves as an index corresponding to a next version of the current analytic model Q−1 1840(Q−1). The query resolution subsystem 120 can then resolve the query 1810 by applying the analytic model Q−1 1820(Q−1) to source data (not depicted in FIG. 18). Applying the analytic model can include executing a particular procedure with the source data as an argument, where the particular procedure is part of the analytic model Q−1 1820(Q−1). The procedure can be executed in numerous ways. For example, executing the procedure can include accessing a subset of the source data from an in-memory cache, and executing a task/utility process that operates on the subset of the source data. Resolving the query 1810 can include generating, using the source data, dashboard data Q 1830(Q) satisfying the query 1810.

The analytic service subsystem 160 can analyze the dashboard data Q 1830(Q) to generate an analytic model Q 1820(Q). Such a model embodies a next (or updated) version of the current analytic model Q−1 1820(Q−1). The analytic service subsystem 160 can operate on the dashboard data 1830(Q) by implementing an analysis technique 1840 by means of at least one utility module of the utility modules 128 included in the query resolution subsystem 120. Similar to implementation of other analysis techniques described herein, rather than obtaining and directly operating on the dashboard data Q 1830(Q), the analytic service subsystem 160 can cause or otherwise direct the at least one utility module to perform one or multiple operations on the dashboard data Q 1830(Q). Such operation(s) constitute the analysis technique 1840. Implementation of the analysis technique 1840 yields the analytic model 1820(Q). The analytic service subsystem 1460 can retain the analytic model Q 1820(Q) within the storage subsystem 1480, for example.

In response to a determination that a current analytic model corresponding to the particular entity is to be updated—e.g., the update criterion is satisfied by source data present in the data source devices 1440—the query resolution subsystem 1420 can again receive the query 1810. Hence, responsive to the query 1810, the query resolution subsystem 1420 can obtain the current analytic model Q 1820(Q) from the storage subsystem 1480. The query resolution subsystem 1420 can then resolve the query 1810 by applying the analytic model Q 1820(Q) to source data (not depicted in FIG. 18). Applying the analytic model can include executing a particular procedure with the source data as an argument, where the particular procedure is part of the analytic model Q 1820(Q). The procedure can be executed in numerous ways. For example, executing the procedure can include accessing a subset of the source data from an in-memory cache, and executing a task/utility process that operates on the subset of the source data. Resolving the query 1810 can include generating, using the source data, dashboard data Q+1 1830(Q+1) satisfying the query 1810.

The analytic service subsystem 1460 can analyze the dashboard data Q+1 1830(Q+1) to generate an analytic model Q+1 1820(Q+1). Such a model embodies a next (or updated) version of the current analytic model Q 1820(Q). The analytic service subsystem 160 can operate on the dashboard data Q+1 1830(Q+1) by implementing an analysis technique 1840 by means of at least one utility module of the utility modules 1428 included in the query resolution subsystem 1420. Similar to implementation of other analysis techniques described herein, rather than obtaining and directly operating on the dashboard data Q+1 1830(Q+1), the analytic service subsystem 1460 can cause or otherwise direct the at least one utility module to perform one or multiple operations on the dashboard data Q+1 1830(Q+1). As mentioned, such operation(s) constitute the analysis technique 1840. Implementation of the analysis technique 1840 yields the analytic model Q+1 1820(Q+1). The service subsystem 160 can retain the analytic model Q+1 1820(Q+1) within the storage subsystem 1480, for example.

Because an analytic model of the analytic models 1484 can include a computer-operable object having a set of one or multiple numeric parameters and also having one or multiple procedures, the analytic model can be applied to input data by implementing at least one of the procedure(s) using the input data as an argument. The input data can be indicative of a type of entity consistent with the entity represented by the analytic model. For example, in case the entity represented by the analytic model is a “good student,” the entity identified by the input data can be a “student.” The input data, however, may not be part of the source data that have been used to generate the analytic model. Additionally, or in the alternative, the input data may not include one or more records (e.g., data records) associated with at least one field or dimension that is associated with a metric and/or aggregation that forms the basis for, and/or is associated with, the analytic model. As an example, using the previous example above where the entity represented by the analytic model is a “good student,” the source data may include data records for each field/dimension within the listing 1650 shown in FIG. 16B, and the analytic model may be based on a metric and/or aggregation that uses data records for a given period of time associated with the “math score,” “reading score,” and “writing score” fields/dimensions. However, the input data may be for another period of time, and the input data may not include records for the “math score” field beyond those within the source data, but the input data may include data records for the “reading score” and “writing score” fields beyond those within the source data. Applying the analytic model to the input data in this example may yield a value(s) for one or more data records associated with the “math score” that would result in the corresponding metric and/or aggregation based on the input data indicating the entity is still a “good student.” Thus, by applying the analytic model to the input data, a prediction of a state of an entity can be generated. Based on a score or another metric representative of the state, the state may classify the entity as being a “good student” (entity) or an outlier entity. A particular resolution module of the resolution modules 1422 can apply the analytic model to the input data.

In some cases, the analytic service subsystem 1460 can generate a definition of an entity using an image asset. In one example scenario, the image asset can be one of the image asset(s) 1427. In another example scenario, the image asset can be received from the client device 1430 or another type of origination device. More specifically, in such an example scenario, a gateway component included in the backend platform devices 1410 can receive the image asset and can then send the image asset to the analytic service subsystem 1460. Further, or in some cases, the analytic service subsystem 1460 may guide (or bias) the generation of an analytic model corresponding to the definition of the entity by drawing a machine-learned conclusion from the image asset, regardless of the source of the image asset. Guiding the (or biasing) the generation of the analytic model can include paring down or otherwise bounding the subspace of data models relied on to generate the analytic model.

In order to generate a definition of an entity (e.g., a student or an electric vehicle) using an image asset, such as a precursor definition, the analytic service subsystem 1460 can implement a particular analysis technique of the analysis techniques 1468. In some cases, the particular analysis technique can be implemented by means of one or more utility modules of the utility modules 1428. In other cases, the analytic service subsystem 1460 can implement the particular analysis technique. The particular analysis technique can be an image processing technique that applies a machine-learning model trained to identify a type of graphical object within a digital image corresponding to the image asset (e.g., imaging data), a placement of the graphical object within a layout of graphical objects, and a prominence of the graphical object within the layout. For purposes of illustration, such a prominence can represented by a ratio of area occupied by the graphical object and total layout area. The disclosure is not limited in that respect and prominence can be determined in terms of other factors. For instance, prominence can be represented by a color or color palette used in the graphical object, where a warm color can represent greater prominence and a cold color can represent lesser prominence. In addition, or in combination, font size and/or font type also can represent prominence. The machine-learning model can include a convolutional neural network (CNN), for example. The type of graphical object can include, for example, a bar chart of a metric (or aggregation) as a function of a particular field; plot of a field as a function of time; plot of a metric (or aggregation) as a function of time; table and field(s) included in the table. The machine-learning model can generate a ranking of metrics and fields based on one or a combination of respective type of graphical object(s) present in the image asset, respective placement of the graphical object(s), and respective prominence of the graphical object(s). The ranking can be used to select one or more metrics and one or more fields to constrain the generation of meta models, for example. Selected metrics and fields can constitute a definition (precursor or otherwise) of the entity.

One or more analysis modules of the analysis modules 1464 can direct at least one of the utility modules 1428 to apply the machine-learning model to imaging data and/or imaging metadata that form the image asset. Content (or values) of pixels, as defined by the imaging data, can yield type, placement, and prominence of a graphical object. A ranking of metrics and fields identified in the image asset can be determined as a result of applying the machine-learning model. The machine-learning model can be trained by using a group of annotated image assets, where a one label or a multi-dimensional tuple of labels indicates type, placement, and prominence or one or more graphical objects in the image asset.

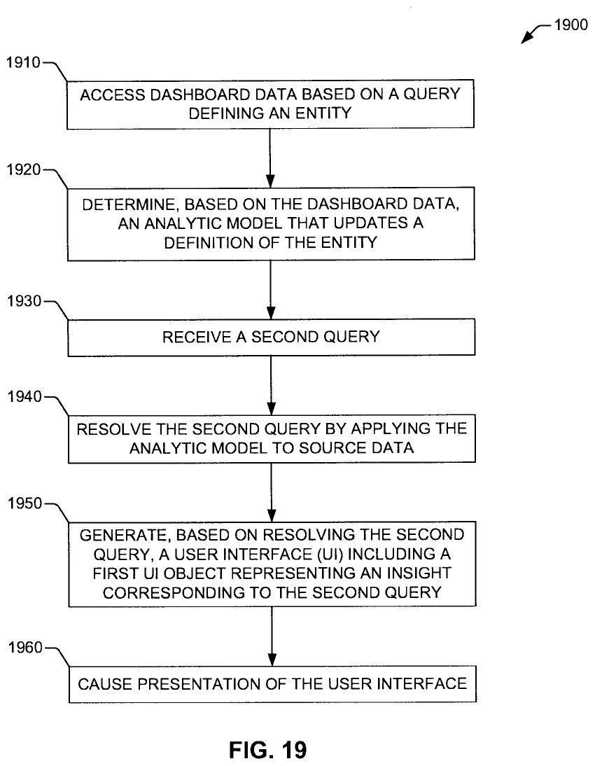

FIG. 19 shows an example of a method 1900 for generation of data insights, in accordance with one or more embodiments of this disclosure. A computing device or a system of computing devices can implement the example method 1900 in its entirety or in part. To that end, each computing device can include computing resources that can implement, or can permit implementing, at least one of the blocks included in the example method 1900. The computing resources include, for example, central processing units (CPUs), graphics processing units (GPUs), tensor processing units (TPUs), memory, disk space, incoming bandwidth, and/or outgoing bandwidth, interface(s) (such as I/O interfaces or APIs, or both); controller devices(s); power supplies; a combination of the foregoing; and/or similar resources. For instance, the system of computing devices can include programming interface(s); an operating system; software for configuration and or control of a virtualized environment; firmware; and similar resources.

The system of computing devices can be referred to as a computing system. In some cases, the computing system can host the query resolution subsystem 1420 and the storage subsystem 1480, and the analytic service subsystem 1460. In other cases, the analytic service subsystem 1460 can be functionally coupled to the computing system. Thus, the computing system can execute one or more of the operations of the example method 1900 by at least executing modules that form part of at least some of those subsystems.

At block 1910, the computing system can access dashboard data based on a client query (or query) defining an entity. The client query can be received from a client device (e.g., client device 1430 (FIG. 14)).

At block 1920, the computing system can determine, based on the dashboard data, an analytic model that updates a definition of the entity. The analytic model can constitute, or can include, a computer-operable object having a set of one or multiple numeric parameters and also having one or multiple procedures. At least a first procedure of the procedure(s) includes at least a subset of the set of one or more numeric parameters. That is, the first procedure can be parameterized in terms of at least one parameter of the set of one or more numeric parameters. In some cases, rather than determining the analytic model in such a fashion, the computing system can cause or otherwise direct a computing subsystem to determine the analytic model. The computing subsystem can be functionally coupled to the computing system.

At block 1930, the computing system can receive a second client query (or second query). The second query can be received from the client device or another origination device (e.g., another client device).

At block 1940, the computing system can resolve the second query by applying the analytic model to source data. Resolving the second query can include generating second dashboard data satisfying the second query. In some cases, resolving the second query can include generating data that satisfies the second query. Applying the analytic model can include executing a particular procedure with the source data as an argument, where the particular procedure is part of the analytic model. The procedure can be executed in numerous ways. For example, executing the procedure can include accessing a subset of the source data from an in-memory cache, and executing a task process that operates on the subset of the source data.

At block 1950, the computing system can generate, based on resolving the second query, a user interface (UI) including a first UI object representing a data insight corresponding to the second query.

At block 1960, the computing system can cause presentation of the user interface. As such, the user interface can be one of the user interfaces 1450, for example. Causing presentation of the user interface can include generating a data structure that controls visualization of at least a portion of dashboard data (e.g., dashboard data 1426) at the user interface. The data structure can define, at least partially, a visual representation of at least a portion of the dashboard data 1426. The user interface can be presented at the client device (e.g., client device 1430 (FIG. 14)) via a display device integrated therein or functionally coupled thereto, for example.

Block 1930, block 1940, block 1950, and block 1960 can be reiterated to generate additional data insights and cause presentation of those insights, thus uncovering various aspects of the entity as those aspects may be contained within the source data. In other cases, block 630, block 1940, block 1950, and block 1960 can be reiterated to generate predictions associated with the entity and cause presentation of such predictions. The predictions can be generated using input data that is unavailable within the source data.

Although not illustrated in FIG. 19, in some embodiments of the example method 600, the computing system can determine a second analytic model that further updates the definition of the entity. The second analytic model can be determined based on the second dashboard data. In addition, the computing system can store the further updated definition of the entity.

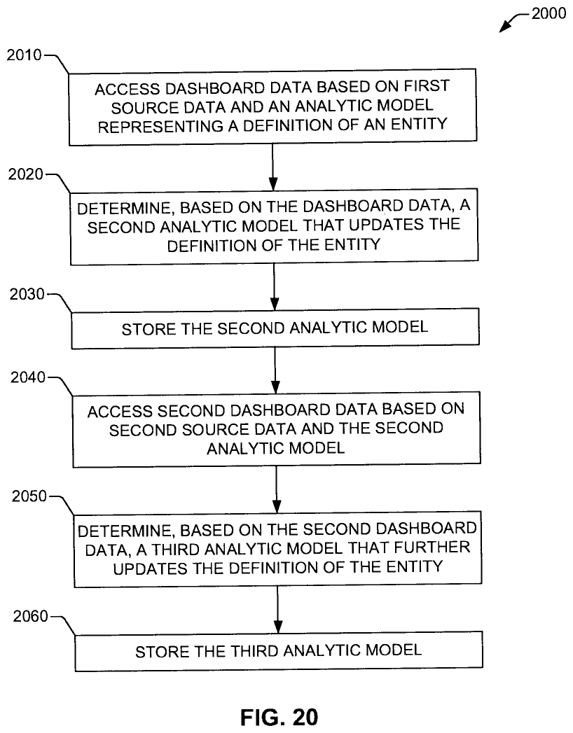

FIG. 20 shows an example of a method 2000 for generating versions of analytic models, in accordance with one or more embodiments of this disclosure. A computing device or a system of computing devices can implement the example method 2000 in its entirety or in part. To that end, each computing device can include computing resources that can implement, or can permit implementing, at least one of the blocks included in the example method 2000. The computing resources include, for example, central processing units (CPUs), graphics processing units (GPUs), tensor processing units (TPUs), memory, disk space, incoming bandwidth, and/or outgoing bandwidth, interface(s) (such as I/O interfaces or APIs, or both); controller devices(s); power supplies; a combination of the foregoing; and/or similar resources. For instance, the system of computing devices can include programming interface(s); an operating system; software for configuration and or control of a virtualized environment; firmware; and similar resources.

The system of computing devices can be referred to as a computing system. In some cases, the computing system can host the query resolution subsystem 1420 and the storage subsystem 1480, and the analytic service subsystem 1460. In other cases, the analytic service subsystem 1460 can be functionally coupled to the computing system. Thus, the computing system can execute one or more of the operations of the example method 2000 by at least executing modules that form part of at least some of those subsystems. In some example scenarios, the computing system that implements the example method 1900 also can implement the example method 2000.

At block 2010, the computing system can access dashboard data based on first source data and an analytic model representing a definition of an entity. Examples of the entity can be “good student,” “good electric vehicle,” “good healthcare site,” and similar.

At block 2020, the computing system can determine a second analytic model that updates the definition of the entity. The second analytic model can be determined based on the dashboard data.

At block 2030, the computing system can store the second analytic model. By storing the second analytic model, an updated (or otherwise new) version of the definition of the entity is retained. The third analytic model can be stored within one or more repositories within the storage subsystem 1480 (FIG. 14), for example.

At block 2040, the computing system can access second dashboard data based on second source data and the second analytic model.

At block 2050, the computing system can determine, based on the second dashboard data, a third analytic model that further updates the definition of the entity. Because the second dashboard data is based on the second source data, the third analytic model can synthetize/reflect a change to the definition of the entity resulting from changes to underlying implicit structure within the second source data relative to the first source data.

At block 2060, the computing system can store the third analytic model. By storing the third analytic model, a further updated (or otherwise new) version of the definition of the entity is retained. The third analytic model can be stored within one or more repositories within the storage subsystem 1480 (FIG. 14), for example.

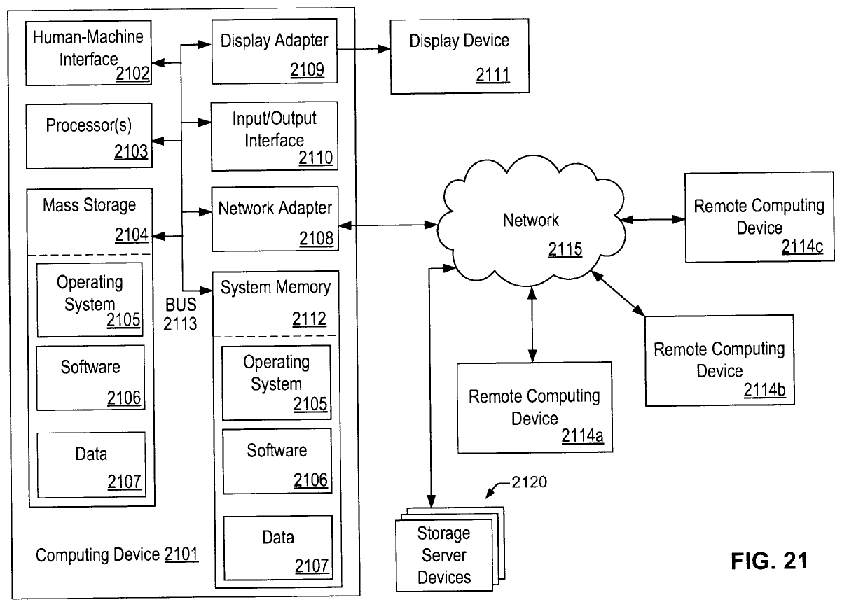

In order to provide some context, the computer-implemented methods and systems of this disclosure can be implemented on the computing environment illustrated in FIG. 21 and described below. Similarly, the computer-implemented methods and systems disclosed herein can utilize one or more computing devices to perform one or more functions in one or more locations. FIG. 21 is a block diagram illustrating an example of a computing system 2100 for performing the disclosed methods and/or implementing the disclosed systems. The computing system 2100 shown in FIG. 21 is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The computer-implemented methods and systems in accordance with this disclosure can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set-top boxes, programmable consumer electronics, network PCs, minicomputers, mainframe computers, distributed computing environments that comprise any of the above systems or devices, and the like.

The processing of the disclosed computer-implemented methods and systems can be performed by software components. The disclosed systems and computer-implemented methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed computer-implemented methods can also be practiced in grid-based and distributed computing environments where tasks are performed by remote processing devices that are linked through a communications network. In a distributed computing environment, program modules can be located in both local and remote computer storage media including memory storage devices.

Further, the systems and computer-implemented methods disclosed herein can be implemented via a general-purpose computing device in the form of a computing device 2101. The components of the computing device 2101 can comprise, but are not limited to, one or more processors 2103, a system memory 2112, and a system bus 2113 that functionally couples various system components including the one or more processors 2103 to the system memory 2112. The system can utilize parallel computing.

The system bus 2113 represents one or more of several possible types of bus structures, including a memory bus or memory controller, a peripheral bus, an accelerated graphics port, or local bus using any of a variety of bus architectures. The bus 2113, and all buses specified in this description can also be implemented over a wired or wireless network connection and each of the subsystems, including the one or more processors 2103, one or more mass storage devices 2104 (referred to as mass storage 2104), an operating system 2105, software 2106, data 2107, a network adapter 2108, the system memory 2112, an Input/Output Interface 2110, a display adapter 2109, a display device 2111, and a human-machine interface 2102, can be contained within one or more remote computing devices 2114a, b, c at physically separate locations, connected through buses of this form, in effect implementing a fully distributed system.

The computing device 2101 typically comprises a variety of computer-readable media. Exemplary readable media can be any available media that is accessible by the computing device 2101 and comprises, for example and not meant to be limiting, both volatile and non-volatile media, removable and non-removable media. The system memory 2112 comprises computer readable media in the form of volatile memory, such as random access memory (RAM), and/or non-volatile memory, such as read only memory (ROM). The system memory 2112 typically contains data such as the data 2107 and/or program modules such as the operating system 2105 and the software 2106 that are immediately accessible to and/or are presently operated on by the one or more processors 2103.

The computing device 2101 can also comprise other removable/non-removable, volatile/non-volatile computer storage media. As an example, FIG. 21 shows the mass storage 2104 which can provide non-volatile storage of computer code, computer readable instructions, data structures, program modules, and other data for the computing device 2101. For example and not meant to be limiting, the mass storage 2104 can be embodied in, or can include, a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage 2104, including by way of example, the operating system 2105 and the software 2106. Each of the operating system 2105 and the software 2106 (or some combination thereof) can comprise elements of the programming and the software 2106. The data 2107 can also be stored on the mass storage 2104. The data 2107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems. The software 2106 can include, in some cases, the resolution modules 122, the utility modules 128, and the analysis modules 164. Execution of the software 2106 by the processor(s) 2103 can cause the computing device 2101 to provide at least some of the functionality described herein connection with query composition using a user interface and/or visualization of data responsive to the query as is described herein.

In another aspect, the user can enter commands and information into the computing device 2101 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the one or more processors 2103 via the human-machine interface 2102 that is coupled to the system bus 2113, but can be connected by other interface and bus structures, such as a parallel port, game port, an IEEE 1394 Port (also known as a Firewire port), a serial port, or a universal serial bus (USB).

In yet another aspect, the display device 2111 can also be connected to the system bus 2113 via an interface, such as the display adapter 2109. It is contemplated that the computing device 2101 can have more than one display adapter 2109 and the computing device 2101 can have more than one display device 2111. For example, the display device 2111 can be a monitor, an LCD (Liquid Crystal Display), or a projector. In addition to the display device 2111, other output peripheral devices can comprise components such as speakers (not shown) and a printer (not shown) which can be connected to the computing device 2101 via the Input/Output Interface 2110. Any operation and/or result of the methods can be output in any form to an output device. Such output can be any form of visual representation, including, but not limited to, textual, graphical, animation, audio, tactile, and the like. The display device 2111 and computing device 2101 can be part of one device, or separate devices.

The computing device 2101 can operate in a networked environment using logical connections to one or more remote computing devices 2114a, b, c and/or one or multiple storage server devices 520. For example, a remote computing device can be a personal computer, portable computer, smartphone, a server, a router, a network computer, a peer device or other common network node, and so on. In some cases, the one or multiple storage server devices 2120 can embody, or can constitute, the storage subsystem 1480 (FIG. 14). Logical connections between the computing device 2101 and a remote computing device 2114a, b, c and a server storage device of the server storage device(s) 2120 can be made via a network 2115, such as a local area network (LAN) and/or a general wide area network (WAN). Such network connections can be through the network adapter 2108. The network adapter 2108 can be implemented in both wired and wireless environments. In an aspect, one or more of the remote computing devices 2114a, b, c can comprise an external engine and/or an interface to the external engine.

For purposes of illustration, application programs and other executable program components such as the operating system 2105 are illustrated herein as discrete blocks, although it is recognized that such programs and components reside at various times in different storage components of the computing device 2101, and are executed by the one or more processors 2103 of the computer. An implementation of the software 2106 can be stored on or transmitted across some form of computer-readable media. Any of the disclosed methods can be performed by computer readable instructions embodied on computer-readable media. Computer-readable media can be any available media that can be accessed by a computer. By way of example and not meant to be limiting, computer-readable media can comprise “computer storage media” and “communications media.” “Computer storage media” comprise volatile and non-volatile, removable and non-removable media implemented in any methods or technology for storage of information such as computer-readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

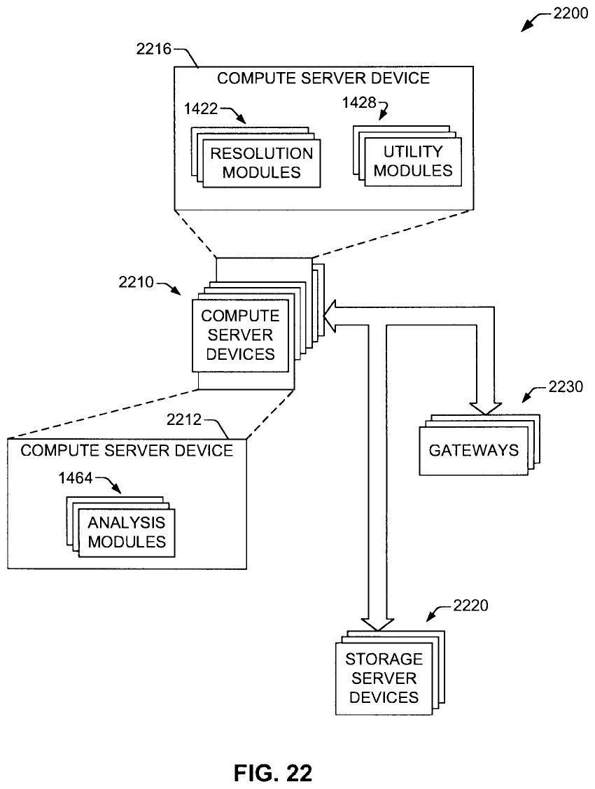

FIG. 22 is a schematic block diagram of an example of a computing system 2200 for closed-loop generation of insights from source data, in accordance with one or more embodiments of this disclosure. The computing system 2200 can embody, or can include, the query resolution subsystem 1420, the analytic service subsystem 1460, and the storage subsystem 1480. Accordingly, the example computing system 2200 can provide the functionality described herein in connection with closed-loop generation of insights from source data.

The example computing system 2200 includes two types of server devices: Compute server devices 2210 and storage server devices 2220. A subset of the compute server devices 2210, individually or collectively, can host the various modules that constitute the analysis service subsystem 1460. For the sake of illustrations a particular compute server device 2212 within such a subset is schematically depicted as hosting such modules. In addition, another subset of the compute server devices 2210, individually or collectively, can host the various modules that constitute the query resolution subsystem 1420. For the sake of illustration, a particular compute server device 2216 within such a subset is schematically depicted as hosting such modules. Further, at least one server device of the compute server devices 2210 can host the in-memory storage 1424. The at least one server device can be configured as part of a virtual private cloud (VPC), for example. Therefore, a server device in the subset of the compute server devices 2210 can access the in-memory storage 1444 via an endpoint SSE connection.

At least the subset of the compute server devices 2210 can be functionally coupled to one or several of the storage server devices 2220. That coupling can be direct or can be mediated by at least one of gateway devices 2230. The storage server devices 2220 include data and metadata that can be used to implement the functionality described herein in connection with closed-loop generation of insights from source data. Some of the storage server devices 2220 can embody, or can constitute, the storage subsystem 1480 (FIG. FIG. 14) and, thus, can contain definitions 1482 and analytic models 1484. Additionally, or in some cases, a subset of the storage server device 2220 embody the repository 1466 (FIG. 14) and, thus, can contain the analysis techniques 1468, for example.

Each one of the gateway devices 2230 can include one or many processors functionally coupled to one or many memory devices that can retain application programming interfaces (APIs) and/or other types of program code for access to the compute server devices 2210 and storage server devices 2220. Such access can be programmatic, via an appropriate function call, for example. The subset of the compute server devices 2210 that host the query resolution subsystem 1420 also can use API(s) supplied by the gateway devices 2230 in order access the VPC that hosts the in-memory storage 1424 (FIG. 14) and/or the analytic service subsystem 1460.

It is to be understood that the computer-implemented methods and systems described here are not limited to specific operations, processes, components, or structure described, or to the order or particular combination of such operations or components as described. It is also to be understood that the terminology used herein is for the purpose of describing exemplary embodiments only and is not intended to be restrictive or limiting.

As used herein the singular forms “a,” “an,” and “the” include both singular and plural referents unless the context clearly dictates otherwise. Values expressed as approximations, by use of antecedents such as “about” or “approximately,” shall include reasonable variations from the referenced values. If such approximate values are included with ranges, not only are the endpoints considered approximations, the magnitude of the range shall also be considered an approximation. Lists are to be considered exemplary and not restricted or limited to the elements comprising the list or to the order in which the elements have been listed unless the context clearly dictates otherwise.

Throughout the specification and claims of this disclosure, the following words have the meaning that is set forth: “comprise” and variations of the word, such as “comprising” and “comprises,” mean including but not limited to, and are not intended to exclude, for example, other additives, components, integers, or operations. “Include” and variations of the word, such as “including” are not intended to mean something that is restricted or limited to what is indicated as being included, or to exclude what is not indicated. “May” means something that is permissive but not restrictive or limiting. “Optional” or “optionally” means something that may or may not be included without changing the result or what is being described. “Prefer” and variations of the word such as “preferred” or “preferably” mean something that is exemplary and more ideal, but not required. “Such as” means something that serves simply as an example.

Operations and components described herein as being used to perform the disclosed methods and construct the disclosed systems are illustrative unless the context clearly dictates otherwise. It is to be understood that when combinations, subsets, interactions, groups, etc. of these operations and components are disclosed, that while specific reference of each various individual and collective combinations and permutation of these may not be explicitly disclosed, each is specifically contemplated and described herein, for all methods and systems. This applies to all aspects of this application including, but not limited to, operations in disclosed methods and/or the components disclosed in the systems. Thus, if there are a variety of additional operations that can be performed or components that can be added, it is understood that each of these additional operations can be performed and components added with any specific embodiment or combination of embodiments of the disclosed systems and methods.

Embodiments of this disclosure may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices, whether internal, networked, or cloud-based.

Embodiments of this disclosure have been described with reference to diagrams, flowcharts, and other illustrations of computer-implemented methods, systems, apparatuses, and computer program products. Each block of the block diagrams and flowchart illustrations, and combinations of blocks in the block diagrams and flowchart illustrations, respectively, can be implemented by processor-accessible instructions. Such instructions can include, for example, computer program instructions (e.g., processor-readable and/or processor-executable instructions). The processor-accessible instructions can be built (e.g., linked and compiled) and retained in processor-executable form in one or multiple memory devices or one or many other processor-accessible non-transitory storage media. These computer program instructions (built or otherwise) may be loaded onto a general-purpose computer, special purpose computer, or other programmable data processing apparatus to produce a machine. The loaded computer program instructions can be accessed and executed by one or multiple processors or other types of processing circuitry. In response to execution, the loaded computer program instructions provide the functionality described in connection with flowchart blocks (individually or in a particular combination) or blocks in block diagrams (individually or in a particular combination). Thus, such instructions which execute on the computer or other programmable data processing apparatus create a means for implementing the functions specified in the flowchart blocks (individually or in a particular combination) or blocks in block diagrams (individually or in a particular combination).

These computer program instructions may also be stored in a computer-readable memory that can direct a computer or other programmable data processing apparatus to function in a particular manner, such that the instructions stored in the computer-readable memory produce an article of manufacture including processor-accessible instruction (e.g., processor-readable instructions and/or processor-executable instructions) to implement the function specified in the flowchart blocks (individually or in a particular combination) or blocks in block diagrams (individually or in a particular combination). The computer program instructions (built or otherwise) may also be loaded onto a computer or other programmable data processing apparatus to cause a series of operations to be performed on the computer or other programmable apparatus to produce a computer-implemented process. The series of operations can be performed in response to execution by one or more processor or other types of processing circuitry. Thus, such instructions that execute on the computer or other programmable apparatus provide operations for implementing the functions specified in the flowchart blocks (individually or in a particular combination) or blocks in block diagrams (individually or in a particular combination).

Accordingly, blocks of the block diagrams and flowchart illustrations support combinations of means for performing the specified functions in connection with such diagrams and/or flowchart illustrations, combinations of operations for performing the specified functions and program instruction means for performing the specified functions. Each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

The methods and systems can employ artificial intelligence techniques such as machine learning and iterative learning. Examples of such techniques include, but are not limited to, expert systems, case-based reasoning, Bayesian networks, behavior-based AI, neural networks, fuzzy systems, evolutionary computation (e.g. genetic algorithms), swarm intelligence (e.g. ant algorithms), and hybrid intelligent systems (e.g. expert inference rules generated through a neural network or production rules from statistical learning).

While the computer-implemented methods, apparatuses, devices, and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is in no way intended that an order be inferred, in any respect. This holds for any possible non-express basis for interpretation, including: matters of logic with respect to arrangement of operations or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising,
receiving, via a user interface (UI) output by a computing device, at least one selection of at least one UI element of a plurality of UI elements associated with source data for an entity;
determining, based on the at least one selection of the at least one UI element and the source data, a metric associated with the entity;
generating, based on the metric, a first UI object, wherein the first UI object is indicative of the metric based on the source data;
causing the first UI object to be output at the UI, wherein the output of the first UI object is associated with imaging data and imaging metadata;
generating, via a machine-learning model, based on the imaging data and the imaging metadata, and based on input data associated with the entity, a second UI object, wherein the second UI object is indicative of the metric based on the input data, wherein at least one portion of the input data differs from the source data, and wherein the second UI object differs from the first UI object based on the at least one portion of the input data that differs from the source data; and
causing the second UI object to be output at the UI.

2. The method of claim 1, wherein the source data comprises a plurality of fields, and wherein the at least one UI element is associated with at least one field of the plurality of fields.

3. The method of claim 2, wherein the metric comprises an aggregation of data records within the source data based on the at least one field.

4. The method of claim 2, wherein the at least one portion of the input data that differs from the source data is associated with the at least one field.

5. The method of claim 1, wherein the machine-learning model comprises a convolutional neural network.

6. The method of claim 1, wherein the first UI object comprises a first chart or a first graph indicative of the metric based on the source data, and wherein the second UI object comprises a second chart or a second graph indicative of the metric based on the input data.

7. The method of claim 1, wherein causing the first UI object to be output at the UI comprises: determining, based on the imaging metadata, a layout for the first UI object, wherein the imaging metadata defines the layout.

8. The method of claim 7, wherein causing the second UI object to be output at the UI comprises: determining, based on the layout for the first UI object, a placement and a prominence for the second UI object within the layout.

9. The method of claim 1, wherein the machine-learning model is trained to identify a type of a UI object within imaging data associated with the UI object, a placement of the UI object within a layout of at least the UI object, and a prominence of the UI object within the layout.

10. The method of claim 1, wherein the source data is associated with a first period of time, and wherein the input data is associated with a second period of time that differs from the first period of time.

11. One or more non-transitory computer-readable media comprising processor-executable instructions that, when executed by at least one processor of a computing device, cause the computing device to:
receive, via a user interface (UI) output by the computing device, at least one selection of at least one UI element of a plurality of UI elements associated with source data for an entity;
determine, based on the at least one selection of the at least one UI element and the source data, a metric associated with the entity;
generate, based on the metric, a first UI object, wherein the first UI object is indicative of the metric based on the source data;
cause the first UI object to be output at the UI, wherein the output of the first UI object is associated with imaging data and imaging metadata;
generate, via a machine-learning model, based on the imaging data and the imaging metadata, and based on input data associated with the entity, a second UI object, wherein the second UI object is indicative of the metric based on the input data, wherein at least one portion of the input data differs from the source data, and wherein the second UI object differs from the first UI object based on the at least one portion of the input data that differs from the source data; and
cause the second UI object to be output at the UI.

12. The one or more non-transitory computer-readable storage media of claim 11, wherein the source data comprises a plurality of fields, and wherein the at least one UI element is associated with at least one field of the plurality of fields.

13. The one or more non-transitory computer-readable storage media of claim 12, wherein the metric comprises an aggregation of data records within the source data based on the at least one field.

14. The one or more non-transitory computer-readable storage media of claim 12, wherein the at least one portion of the input data that differs from the source data is associated with the at least one field.

15. The one or more non-transitory computer-readable storage media of claim 11, wherein the machine-learning model comprises a convolutional neural network.

16. The one or more non-transitory computer-readable storage media of claim 11, wherein the first UI object comprises a first chart or a first graph indicative of the metric based on the source data, and wherein the second UI object comprises a second chart or a second graph indicative of the metric based on the input data.

17. The one or more non-transitory computer-readable storage media of claim 11, wherein the processor-executable instructions that cause the first UI object to be output at the UI further cause the computing device to determine, based on the imaging metadata, a layout for the first UI object, wherein the imaging metadata defines the layout.

18. The one or more non-transitory computer-readable storage media of claim 17, wherein the processor-executable instructions that cause the computing device to cause the second UI object to be output at the UI further cause the computing device to determine, based on the layout for the first UI object, a placement and a prominence for the second UI object within the layout.

19. The one or more non-transitory computer-readable storage media of claim 11, wherein the machine-learning model is trained to identify a type of a UI object within imaging data associated with the UI object, a placement of the UI object within a layout of at least the UI object, and a prominence of the UI object within the layout.

20. The one or more non-transitory computer-readable storage media of claim 11, wherein the source data is associated with a first period of time, and wherein the input data is associated with a second period of time that differs from the first period of time.
